(19) United States
(12) Patent Application Publication
(10) Pub. No.: US 2006/0148957 A1
(43) Pub. Date: Jul. 6, 2006

(54) Blends of oxygen scavenging polyamides with polyesters which contain zinc and cobalt

(75) Inventors: Mark Edward Stewart, Kingsport, TN (US); Robert Noah Estep, Kingsport, TN (US); Benjamin Bradford Gamble, Kingsport, TN (US); Michael Duane Cliffton, Kingsport, TN (US); Donna Rice Quillen, Kingsport, TN (US); Lavonna Suzanne Buehrig, Kingsport, TN (US); Venkat Govindarajan, Naperville, IL (US); Matthew J. Dauzvardis, Manhattan, IL (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignees: Constar International Inc., Philadelphia, PA (US); Eastman Chemical Company, Kingsport, TN (US)

(21) Appl. No.: 11/294,249

(22) Filed: Dec. 5, 2005

Related U.S. Application Data
(60) Provisional application No. 60/633,520, filed on Dec. 6, 2004.

(51) Int. Cl. C08K 3/08

(52) U.S. Cl. 524/440

(57) ABSTRACT

The present invention concerns a method for forming an article by combining a polyester polymer and an oxygen scavenging composition comprising a polyamide in the presence of zinc and a cobalt in a melt processing zone to form a melt; and forming an article such as a sheet or preform from the melt. Also provided are molten formulated polyester polymer compositions containing a blend of a polyethylene terephthalate polymer and a polyamide polymer along with zinc and cobalt. Articles made from the composition are resistant to the transmission of oxygen, possess short induction periods, and have high capacity for sustaining lengthy periods of low oxygen transmission through the wall of the article.

### RELATED APPLICATIONS

This application claims benefit of U.S. Provisional Application No. 60/633,520, filed Dec. 6, 2004, and is incorporated herein by reference in its entirety.

### FIELD OF THE INVENTION

This invention relates to polyester/polyamide blends having excellent gas barrier properties. More particularly, the present invention relates to physical blends of oxygen scavenging polyamide polymers with polyester polymers which contain cobalt and zinc and having improved oxygen scavenging capabilities.

### BACKGROUND OF THE INVENTION

Packaging for food, beverages and in particular beer and fruit juices, cosmetics, medicines, and the like are sensitive to oxygen exposure and require high barrier properties to oxygen and carbon dioxide to preserve the freshness of the package contents and avoid changes in flavor, texture and color. Blends containing small amounts of high barrier polyamides, such as poly(m-xylylene adipamide), typically known commercially as MXD6, with polyesters such as poly(ethylene terephthalate), PET, enhance the passive barrier properties of PET.

To further reduce the entry of oxygen into the contents of the package, small amounts of transition metal salts, such as cobalt salts, can be added to the blend of PET and polyamide to catalyze and actively promote the oxidation of the polyamide polymer, thereby further enhancing the oxygen barrier characteristics of the package. The use of active oxygen scavengers, which chemically remove oxygen migrating through the walls of the package, can be a very effective method to reduce the oxygen transmission rates of plastics used in packaging. While currently available scavengers have found some utility, they also suffer from a variety of drawbacks that include lengthy induction periods before full activity is achieved and/or life spans (capacities) which are too short. In some instances, these deficiencies can be partially addressed by increasing the level of oxygen scavenger in the package structure. However, this typically increases the cost of the final package and produces undesirable effects on the appearance of the package, such as adding haze or color. In addition, increasing the concentration of the oxygen scavenger can complicate manufacture and recycling of the package. Thus, there is a need for improved oxygen scavenging materials that rapidly achieve high scavenging rates.

While salts have been added to PET polymers and polyamide polymers, thereby imparting a measure of active oxygen scavenging activity, we have surprisingly found that when cobalt is added as a catalyst under conditions effective (high temperature, longer residence time) to polymerize PET, the cobalt in the PET polymer was ineffective to impart active oxygen scavenging activity to a blend of that PET polymer and a polyamide polymer. Thus, there remains a need to provide a system containing cobalt in which the cobalt is active to scavenge oxygen.

### SUMMARY OF THE INVENTION

There is now provided a molten formulated polyester polymer composition, preforms, and blow molded containers having improved induction periods for active oxygen scavenging and improved capacity. The molten formulated polyester polymer composition comprises zinc, cobalt, and a physical blend of a polyester polymer and an oxygen scavenging composition, the oxygen scavenging composition present in an amount ranging from 0.10 wt. % to 10 wt. % based on the combined weight of the polyester polymer and the oxygen scavenging composition, and

(A) said polyester polymer comprising:
(i) a polycarboxylic acid component comprising at least 85 mole % of the residues of terephthalic acid, derivates of terephthalic acid, naphthalene-2,6-dicarboxylic acid, derivatives of naphthalene-2,6-dicarboxylic acid, or mixtures thereof, and
(ii) a hydroxyl component comprising at least 50 mole % of the residues of C₂-C₄ aliphatic saturated diols,
wherein (a) and (b) are based on 100 mole percent of the polycarboxylic acid residues and 100 mole percent hydroxyl residues, respectively, in the polyester polymer; and

(B) said oxygen scavenging composition comprising a polyamide polymer, and at least a portion of the cobalt present in said molten composition is virgin cobalt.

There is also provided an isolated solid comprising a sheet, a preform or a bottle, said solid comprising zinc, cobalt, and a blend of a polyester polymer and an oxygen scavenging composition, the oxygen scavenging composition present in an amount ranging from 0.10 wt. % to 10 wt. % based on the combined weight of the polyester polymer and the oxygen scavenging composition, and

(A) said polyester polymer comprising:
(a) a polycarboxylic acid component comprising at least 85 mole % of the residues of terephthalic acid, derivates of terephthalic acid, naphthalene-2,6-dicarboxylic acid, derivatives of naphthalene-2,6-dicarboxylic acid, or mixtures thereof, and
(b) a hydroxyl component comprising at least 50 mole % of the residues of C₂-C₄ aliphatic saturated diols,

based on 100 mole percent of the polycarboxylic acid residues and 100 mole percent hydroxyl residues, respectively, in the polyester polymer; and

(B) said oxygen scavenging composition comprising a polyamide polymer.

There is also provided a solid concentrate comprising a physical blend of a polyester polymer and an oxygen scavenging composition, the oxygen scavenging composition present in an amount ranging from greater than 10 wt. % to 50 wt. % based on the combined weight of the polyester polymer and the oxygen scavenging composition, and

(A) said polyester polymer comprising:
(a) a polycarboxylic acid component comprising at least 85 mole % of the residues of terephthalic acid, derivates of terephthalic acid, naphthalene-2,6-dicarboxylic acid, derivatives of naphthalene-2,6-dicarboxylic acid, or mixtures thereof, and
(b) a hydroxyl component comprising at least 50 mole % of the residues of C₂-C₄aliphatic saturated diols, based on 100 mole percent of the polycarboxylic acid residues and 100 mole percent hydroxyl residues, respectively, in the polyester polymer; and

(B) said oxygen scavenging composition comprising a polyamide polymer; wherein the concentrate further comprises zinc. There is also provided a process for making an article comprising:
(a) combining a polyester polymer and an oxygen scavenging composition comprising a polyamide in the presence of zinc and a cobalt in a melt processing zone to form a melt; and
(b) forming an article such as a sheet or preform directly from the melt.

### BRIEF DESCRIPTION OF THE DRAWINGS

FIG. 1 is a graphical illustration of the oxygen transmission rate into bottles over time made from the resin compositions of the invention compared to resin compositions that either do not contain zinc or made without a polyamide polymer.

FIG. 2 is a graphical illustration of the oxygen transmission rates into bottles over time made from the resin compositions of the invention compared to resin compositions that do not contain zinc.

FIG. 3 is a graphical illustration of the oxygen transmission rates into bottles over time made from the resin compositions of the invention compared to additional resin compositions that do not contain zinc.

FIG. 4 is a graphical illustration of the oxygen transmission rates into bottles over time made from the resin compositions of the invention containing virgin cobalt relative to similar compositions which contain cobalt added only in the melt phase polymerization.

### DETAILED DESCRIPTION OF THE INVENTION

The present invention may be understood more readily by reference to the following detailed description of the invention and the examples provided therein.

It must also be noted that, as used in the specification and the appended claims, the singular forms “a,” “an” and “the” include plural referents unless the context clearly dictates otherwise. For example, reference to processing or making a “polymer,” “preform,” “article,” “container,” or “bottle” is intended to include the processing or making of a plurality of polymers, preforms, articles, containers or bottles. References to a composition containing “an” ingredient or “a” polymer is intended to include other ingredients or other polymers, respectively, in addition to the one named.

As used throughout the specification, “ppm” is by weight.

By “comprising” or “containing” is meant that at least the named compound, element, particle, or method step etc must be present in the composition or article or method, but does not exclude the presence of other compounds, catalysts, materials, particles, method steps, etc, even if the other such compounds, material, particles, method steps etc. have the same function as what is named, unless expressly excluded in the claims.

It is also to be understood that the mention of one or more method steps does not preclude the presence of additional method steps before or after the combined recited steps or intervening method steps between those steps expressly identified. Moreover, the lettering of process steps or ingredients is a convenient means for identifying discrete activities or ingredients and the recited lettering can be arranged in any sequence.

A range of numbers includes and expresses all integers and fractions thereof between the stated range. A range of numbers expressly includes numbers less than the stated endpoints and in-between the stated range.

The intrinsic viscosity values described throughout this description are set forth in dL/g units as calculated from the inherent viscosity measured at 25° C. in 60/40 wt/wt phenol/tetrachloroethane.

The polyester polymers of the invention are thermoplastic. The form of the formulated polyester polymer composition is not limited and can include a composition in the melt phase polymerization, as an amorphous pellet, as a solid stated polymer, as a semi-crystalline particle, as a composition of matter in a melt processing zone, as a bottle preform, or in the form of a stretch blow molded bottle or other articles. The form of polyester polymer particles is not critical, and they are typically formed in the shape of chips, pellets, and flakes.

There is provided an isolated solid comprising a sheet, a preform or a bottle, said solid comprising zinc, cobalt, and a blend of a polyester polymer and an oxygen scavenging composition, the oxygen scavenging composition present in an amount ranging from 0.10 wt. % to 10 wt. % based on the combined weight of the polyester polymer and the oxygen scavenging composition, and

(A) said polyester polymer comprising:
(a) a polycarboxylic acid component comprising at least 85 mole % of the residues of terephthalic acid, derivates of terephthalic acid, naphthalene-2,6-dicarboxylic acid, derivatives of naphthalene-2,6-dicarboxylic acid, or mixtures thereof, and
(b) a hydroxyl component comprising at least 50 mole % of the residues of C₂-C₄ aliphatic saturated diols, based on 100 mole percent of the polycarboxylic acid residues and 100 mole percent hydroxyl residues, respectively, in the polyester polymer; and

(B) said oxygen scavenging composition comprising a polyamide polymer.

Additionally, there is provided a molten formulated polyester polymer composition containing at least a portion of virgin cobalt.

The molten formulated polyester polymer composition contains a physical “blend” of the oxygen scavenging composition and the polyester polymer. A “blend,” may be contrasted to a copolymer or a reactive mixture of ingredients which combine under conditions effective to form a polymer. It is recognized that trace amounts of ingredients may react to form a compound, polymer or copolymer, but in a blend, these reactions do not alter the basic material characteristics of what is known by those of skill as a blend. A blend is deemed present if any one of the following test methods is satisfied, even if the other test methods are not satisfied:

First method: Physical phase separation of the polymer into at least two distinct phases, one phase containing a polyester polymer and another phase containing a polyamide polymer. The phase separation can be conducted by any conventional technique known to those of skill for separating polymers from a blend, such as a solvent extraction, or complete dissolution followed by preferential precipitation. By contrast, it is not possible to phase separate a formulated polyester polymer composition made up exclusively of a copolymer of a polyester polymer and an oxygen scavenging composition by physical means into a distinct polyester phase and a distinct polyamide polymer phase since each of these polymers have copolymerized with each other to form a new and different distinct polymer. While it is possible in such cases to create two distinct phases of a polyester polymer left unreacted or added, along with another phase of the copolymer, a phase of polyamide polymer is not present.

Second method: A blend is a mixture of polyester polymer and polyamide polymer in which the amount of carbonyl ester-amide exchanged is less than or equal to 0.3 mole percent, as measured by the following carbon-13 NMR method. Samples are dissolved in a suitable deuterated solvent and carbon-13 NMR spectra are acquired under conditions which yield quantitative spectra. Peak assignments are obtained from reference samples of the polyester, the polyamide and polymers or oligomers which are prepared under conditions that yield a necessary set of transreaction (or exchange) products. The necessary set of transreaction products is determined by the repeat units present in the polyester and polyamide. Since each reaction between the two polymers produces exchange products in equal amounts, it is not necessary to quantify all possible products—i.e. each trans reaction between polymer 1 (with repeat units represented by A1-B1) and polymer 2 (with repeat units represented by A2-C1) results in one A1-C1 product and one A2-B1 product. Thus it is not necessary to measure both the amount of A1-C1 and A2-B1 product. One only needs to measure either the A1-C1 content or the A2-B1 content to determine the amount of exchange that has occurred. If one or both of the resins are copolymers, then additional products may have to be identified, but it is still not necessary to quantify every possible product (e.g. if polymer 1 is a copolymer, represented as A1-B1 and A1-B2 links, and polymer 2 is a polymer represented as A2-C1 links, each reaction between the two polymers produces an A1-C1 link and either an A2-B1 or an A2-B2. In this case one would have to quantify either the A1-C1 link or the total of the A2-B1 and A2-B2 links, but not all three possible products. This logic can be extended to mixtures which incorporate more components). Once reference spectra for the mixture components and a necessary set of reaction products are determined, the area of the transreacted carbonyl peak(s) in the mixture are compared to the total amount of carbonyl peaks present to arrive at the mole % of carbonyl ester-amide exchanged. In some cases it may be necessary to account for the presence of peaks in the starting materials that lie at or near the same location in the spectrum as the reaction products of interest. In this case the area of the exchanged peak can be corrected by use of reference spectrum collected from a solvent blend of the polyamide and polyester. The area of the peak due to exchanged material is determined by subtraction of the normalized area of the peak in the solvent blend from the peak in the mixture in question.

This method is further illustrated by the following description of its application to the specific case of blends of a polyester based on terephthalic acid (PET) with no additional polycarboxylic acids and a polyamide based on meta-xylylene diamine with no other polyamines (MXD6). For blends of PET and MXD6, samples are dissolved in a suitable deuterated solvent and carbon-13 NMR spectra are acquired at 125 MHz. Spectra were recorded at 47 C, in 10 mm tubes, using a pulse delay of 20 seconds and gated decoupling to eliminate NOE. Under these conditions, quantitative spectra were obtained on an ester-amide copolymer of known composition. Assignments were obtained from reference samples of PET and a reference polymer consisting of terephthalic acid, adipic acid and meta-xylylene diamine. The amide carbonyl resulting from reaction of adipic acid with the amine is found at 173.8 ppm. The amide carbonyl associated with the terephthalic acid-meta-xylylene diamine product is found at 166.8 ppm. The carbonyl associated with PET copolymer is found at 164 ppm. Examination of the spectra of several PET copolymers revealed that a small peak at 166.8 is also present. The origin of this small peak, which interferes with measurement of the intensity of the ester-amide exchange peak, is unknown, but examination of several samples of PET from various sources indicates that its intensity is fairly constant at about 0.3 to 0.8 mole percent of the total PET carbonyl present. A reference spectrum of solvent blended PET with the polyamide of adipic acid and metaxylylene diamine was used to quantify the level of the interfering peak. Subtraction of the calculated intensity of the interfering peak then yielded the corrected intensity of the ester-amide exchange peak.

Thus, the calculations for blends of PET and MXD6 are as follows:
Total carbonyl present=sum of intensities of the peaks at 173.8, 166.8, 164.0 Correction for unknown peak=0.00592*Intensity of PET carbonyl at 164.0 ppm
Moles of ester-amide exchanged carbonyl=Intensity of the peak at 166.8 minus correction for unknown peak intensity.
Mole percent of ester-amide carbonyl exchanged=100*(moles of ester-amide exchanged carbonyl)/(Total moles carbonyl present)

These findings are consistent with those of Prattipati et al, (V. Prattipati, Y. S. Hu, S. Bandi, D. A. Schiraldi, A. Hiltner, E. Baer, S. Mehta, Journal of Polymer Science, Vol. 97, 1361-1370 (2005)) who also examined melt blends of 20 wt % MXD6 in PET by carbon 13 NMR and summarized their findings as follows “ . . . the possibility of transamidization reaction between PET and MXD6 was eliminated”.

Third Method: A physical blend between the polyester polymer and the polyamide polymer is deemed established if a melt processing zone containing the polyester polymer, the polyamide polymer, zinc, and cobalt is operated within the following conditions: The barrel temperature settings are within a range of 250° C. to 300° C., and at either a total cycle time (from introduction into the melt to demolding or extruding into a sheet) of less than 6 minutes or a residence time on the screw of 4 minutes or less, and without the application of vacuum.

The It.V. of a melt containing the polyester polymer and the polyamide polymer is preferably not increased from the melt to solidification. An increase in the It.V. of a molten formulated composition indicates the melt is undergoing polymerization reactions which increase the molecular weight of the polyester polymer.

Component (A) of the formulated polyester polymer composition is a polyester polymer comprising:

(i) a polycarboxylic acid component comprising at least 85 mole % of the residues of terephthalic acid, derivates of terephthalic acid, naphthalene-2,6-dicarboxylic acid, derivatives of naphthalene-2,6-dicarboxylic acid, or mixtures thereof, and

(ii) a hydroxyl component comprising at least 50 mole % of the residues of C₂-C₄ aliphatic saturated diols,

based on 100 mole percent of the polycarboxylic acid residues and 100 mole percent hydroxyl residues in the polyester polymer

The reaction of a polycarboxylic acid compound with a hydroxyl compound during the preparation of the polyester polymer is not restricted to the stated mole % ratios because one may utilize a large excess of a hydroxyl compound if desired, e.g. on the order of up to 200 mole % relative to the 100 mole % of polycarboxylic acid used. The polyester polymer made by the reaction does, however, contain the stated amounts of aromatic dicarboxylic acid residues and a C₂-C₄ aliphatic saturated diol residue.

Derivates of terephthalic acid and naphthalane dicarboxylic acid include C₁-C₄ dialkylterephthalates and C₁-C₄ dialkylnaphthalates, such as dimethylterephthalate and dimethylnaphthalate

Examples of suitable polyester polymers include polyethylene terephthalate homopolymers and copolymers modified with one or more polycarboxylic acid modifiers in a cumulative amount of less than 15 mole %, or 10 mole % or less, or 8 mole % or less, or one or more hydroxyl compound modifiers in an amount of less than than 50 mole %, or less than 15 mole %, or 10 mole % or less, or 8 mole % or less (collectively referred to for brevity as “PET”) and polyethylene naphthalate homopolymers and copolymers modified with a cumulative amount of with less than 15 mole %, or 10 mole % or less, or 8 mole % or less, of one or more polycarboxylic acid modifiers or modified less than 50 mole %, or less than 15 mole %, or 10 mole % or less, or 8 mole % or less of one or more hydroxyl compound modifiers (collectively referred to herein as “PEN”), and blends of PET and PEN. A modifier polycarboxylic acid compound or hydroxyl compound is a compound other than the compound contained in an amount of at least 85 mole %. The preferred polyester polymer is polyalkylene terephthalate, and most preferred is PET.

Preferably, the polyester polymer contains at least 90 mole % ethylene terephthalate repeat units, and most preferably at least 92 mole %, or 94 mole %, based on the moles of all repeat units in the polyester polymers.

In addition to a diacid component of terephthalic acid, derivates of terephthalic acid, naphthalene-2,6-dicarboxylic acid, derivatives of naphthalene-2,6-dicarboxylic acid, or mixtures thereof, the polycarboxylic acid component(s) of the present polyester may include one or more additional modifier polycarboxylic acids. Such additional modifier polycarboxylic acids include aromatic dicarboxylic acids preferably having 8 to 14 carbon atoms, aliphatic dicarboxylic acids preferably having 4 to 12 carbon atoms, or cycloaliphatic dicarboxylic acids preferably having 8 to 12 carbon atoms. Examples of modifier dicarboxylic acids useful as an acid component(s) are phthalic acid, isophthalic acid, naphthalene-2,6-dicarboxylic acid in modifying amounts if not already present, terephthalic acid in modifying amounts if not already present, cyclohexanedicarboxylic acid, cyclohexanediacetic acid, diphenyl-4,4′-dicarboxylic acid, succinic acid, glutaric acid, adipic acid, azelaic acid, sebacic acid, and the like, with isophthalic acid, naphthalene-2,6-dicarboxylic acid, and cyclohexanedicarboxylic acid being most preferable. It should be understood that use of the corresponding acid anhydrides, esters, and acid chlorides of these acids is included in the term “polycarboxylic acid”. It is also possible for trifunctional and higher order polycarboxylic acids to modify the polyester.

The hydroxyl component is made from hydroxyl compounds, which are compounds containing 2 or more hydroxyl groups capable of reacting with a carboxylic acid group. Preferred hydroxyl compounds contain 2 or 3 hydroxyl groups, more preferably 2 hydroxyl groups, and preferably are C₂-C₄ alkane diols, such as ethylene glycol, propane diol, and butane diol, among which ethylene glycol is most preferred for container applications. In addition to these diols, other modifier hydroxyl compound component(s) may include diols such as cycloaliphatic diols preferably having 6 to 20 carbon atoms and/or aliphatic diols preferably having 3 to 20 carbon atoms. Examples of such diols include diethylene glycol; triethylene glycol; 1,4-cyclohexanedimethanol; propane-1,3-diol and butane-1,4-diol (which are considered modifier diols if ethylene glycol residues are present in the polymer in an amount of at least 85 mole % based on the moles of all hydroxyl compound residues); pentane-1,5-diol; hexane-1,6-diol; 3-methylpentanediol-(2,4); neopentyl glycol; 2-methylpentanediol-(1,4); 2,2,4-trimethylpentane-diol-(1,3); 2,5-ethylhexanediol-(1,3); 2,2-diethyl propane-diol-(1, 3); hexanediol-(1,3); 1,4-di-(hydroxyethoxy)-benzene; 2,2-bis-(4-hydroxycyclohexyl)-propane; 2,4-dihydroxy-1,1,3,3-tetramethyl-cyclobutane; 2,2-bis-(3-hydroxyethoxyphenyl)-propane; and 2,2-bis-(4-hydroxypropoxyphenyl)-propane. Typically, polyesters such as polyethylene terephthalate are made by reacting a glycol with a dicarboxylic acid as the free acid or its dimethyl ester to produce an ester monomer and/or oligomers, which are then polycondensed to produce the polyester.

Preferred modifiers include isophthalic acid, naphthalenic dicarboxylic acid, trimellitic anhydride, pyromellitic dianhydride, 1,4-cyclohexane dimethanol, and diethylene glycol

The amount of the polyester polymer in the formulated polyester polymer composition ranges from greater than 50.0 wt. %, or from 80.0 wt. %, or from 90.0 wt. %, or from 95.0 wt. %, or from 96.0 wt. %, or from 97 wt. %, or from 98 wt %, and up to about 99.90 wt. %, based on the combined weight of all polyester polymers and all polyamide polymers. The formulated polyester polymer compositions may also include blends of formulated polyester polymer compositions with other thermoplastic polymers such as polycarbonate. It is preferred that the polyester composition should comprise a majority of the formulated polyester polymer composition of the inventions, more preferably in an amount of at least 80 wt. %, or at least 90 wt. %, based on the weight of the composition (excluding fillers, inorganic compounds or particles, fibers, impact modifiers, or other polymers serve as impact modifiers or which form a discontinuous phase such as may be found in cold storage food trays).

The polyester compositions can be prepared by polymerization procedures known in the art sufficient to effect esterification and polycondensation. Polyester melt phase manufacturing processes include direct condensation of a dicarboxylic acid with the diol, optionally in the presence of esterification catalysts, in the esterification zone, followed by polycondensation in the prepolymer and finishing zones in the presence of a polycondensation catalyst; or ester exchange usually in the presence of a transesterification catalyst in the ester exchange zone, followed by prepolymerization and finishing in the presence of a polycondensation catalyst, and each may optionally be solid stated according to known methods.

The It.V. of polyester polymer ranges from about at least 0.55, or at least 0.65, or at least 0.70, or at least 0.75, and up to about 1.15 dL/g. The molten polymer from the melt phase polymerization may be allowed to solidify and/or obtain any degree of crystallinity from the melt. Alternatively, the molten polymer can be first solidified and then crystallized from the glass

Component (B) of the polyester composition is an oxygen scavenging composition comprising a polyamide polymer. By a “polyamide polymer” as used herein is meant a polyamide polymer having random or block amide repeating linkages. The polyamide polymer can be a homopolymer, a copolymer, or a graft copolymer or homopolymer. In one embodiment, at least 80%, or at least 85%, or at least 90% of the linkages between two different monomer residues in the polyamide polymer are amide linkages. The polyamide polymer preferably also has less than 10.0 mole % of polyester linkages, more preferably less than 5 mole % polyester linkages, and even more preferably less than 2.5 mol % polyester linkages, or less than 1.5 mole %, or less than 1.0 mole %, or less than 0.5 mole %, or below detection limits, or zero. Where a polyester linkage is defined as the reaction product of carboxylic acid and a hydroxyl compound in the backbone of the polymer and the mole % is relative to the total number of amide or ester groups in the backbone

The formulated polyester polymer composition may, in addition to the polyamide, contain other types of oxygen scavenging polymers. For example copolymers of α-olefins with polyamines and aromatic compounds (not polymers) having benzylic hydrogen atoms may be used in addition to the polyamide oxygen scavenger. The amount of oxygen scavengers other than polyamide polymers is desirably less than 30 wt. %, or less than 20 wt. %, or less than 10 wt. %, or less than 5 wt. %, or less than 2 wt. %, or less than 1 wt. %, or less than 0.5 wt. %, or less than 0.1 wt. % based on the combined weights of components A) and B).

The formulated polyester polymer composition of the invention contains the polyamide polymer in an amount ranging from 0.1 wt. % up to 10 wt. % of the combined weight of the polyester polymer and the polyamide polymer. The particular amount of polyamide chosen will depend upon the requirements of the particular application. In choosing the amount of desired polyamide, consideration is given for factors such as color, the effective reduction in oxygen transmission, and costs, which are each impacted by the amount and type of polyamide used. In general, suitable amounts of polyamide for bottle applications containing water, beer, and fruit juices ranges from about 1.0 wt. %, or from about 1.25 wt. %, and up to about 7 wt. %, or up to about 6 wt. %, or up to 5.0 wt. %, or up to 3.0 wt. %, or up to 2.5 wt. %. Greater amounts can be used especially when the package volume decreases because the surface area of smaller packages increases. However, for economic reasons, and to control haze and color, it is desirable to use the least amount of oxygen scavenging composition effective to impart the desired level of oxygen scavenging and freshness to the package contents. We have found that amounts of polyamide as low as 1.3 wt. % have proven effective. Accordingly, in a most preferred embodiment, the amount of polyamide polymer ranges from 1.0 wt. %, or from 1.20 wt. %, and up to about 3.0 wt. %, or less than 2.5 wt. %, or up to 2.0 wt. %.

If one desires, a concentrate of the polyester composition of the invention can be made and let down into an extruder or injection molding machine at a desired rate to yield a polyester composition containing the final desired amount of polyamide compound in the finished product. The concentrate contains a concentration of polyamide polymer which is higher than the concentration of polyamide polymer in a container. In this way, a converter retains the flexibility to decide the level of polyamide in the finished product. Thus, there is also provided a concentrate containing the polyester polymer (A), and an oxygen scavenging composition (B) comprising a polyamide polymer in an amount ranging from greater than 10.0 wt %, or at least 15.0 wt. %, or at least 20 wt. %, and up to about 50 wt. %, based on the weight of components (A) and (B).

The polyamide compound may be incorporated into the finished article by various methods. The polyester/polyamide blends of the present invention involve preparing the polyester and polyamide by known processes. The polyester polymer and polyamide polymer are separately, or in combination, optionally dried in an atmosphere of dried air or dried nitrogen, and/or are processed under reduced pressure. In one method of incorporation, the polyester polymer particles and the polyamide polymer are melt compounded, for example, in a single or twin screw extruder. After completion of the melt compounding, the extrudate is withdrawn in strand form, and recovered according to the usual way such as cutting. Instead of melt compounding, the polyester and polyamide may be dry-blended. A separate stream of polyester polymer particles may be fed to a melt processing zone for making the article, and the concentrate is let down into the melt processing zone in an amount to provide the desired level of polyamide in the finished article. Alternatively, a stream of polyester polymer particles may be fed separately, or in combination as a dry pellet blend, with a stream of polyamide polymer neat or in a liquid carrier to the melt processing zone for making the finished article

The polyamide polymer can be added to the polyester polymer particles or melt as a neat stream of polyamide polymer, or in a suitable carrier. Suitable liquid carriers are compounds which are the same as one of the reactants used to make the polyester polymer in the melt phase (e.g. ethylene glycol). Alternatively, increasing the molecular weight of the polymer may not be desired, in which case a non-reactive carrier should be used.

The number average molecular weight of the polyamide polymer is not particularly limited to effectuate a measure of oxygen scavenging. The Mn is desirably above 1000, and 45,000 or less. In one embodiment the Mn of the polyamide polymer is at least 2500, or at least 3500, and up to about 25,000. If desired, low molecular weight polyamides may be used in the range of 2500 to about 12,000 or less, and even 7000 or less.

The polyamide polymer component (B) is made by reacting a polycarboxylic acid compound and a polyamine compound, or made by any other known methods, such as through lactams, using amino acids, or acid chlorides reacted with diamines.

In one embodiment, the polyamide polymer is a reaction product containing moieties, preferably in an amount of at least 40 mole %, or at least 70 mole %, or at least 80 mole %, represented by the general formula: 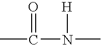
and the number of such moieties present in the polymer ranges from 1 to 200, or from 50 to 150. Preferably, at least 50% of the repeat units contain an active methylene group, such as an allylic group, an oxyalkylene hydrogen, or more preferably at least 50% of the repeat units contain a benzylic hydrogen group.

Examples of acids used to make the polyamide include polycarboxylic acid compounds, amino acids, and chlorides, derivates or anhydrides thereof, including lactams, having from 4 to 50 carbon atoms, or an average of 4 to 24 carbon atoms, or an average of 4 to 12 carbon atoms. Examples of amines used to make the polyamide polymer include polyamines, amino acids, and the derivatives and anhydrides thereof, including lactams, having from 2 to 50 carbon atoms, or from 2 to 22 carbon atoms.

More specific examples of suitable acids include adipic acid, isophthalic acid, terephthalic acid, 1,4-cyclohexanedicarboxylic acid, resorcinol dicarboxylic acid, naphthalene-2,6-dicarboxylic acid, derivates thereof, tartaric acid, citric acid, malic acid, oxalic acid, adipic acid, malonic acid, galactaric acid. 1,2-cyclopentane dicarboxylic acid, maleic acid, fumaric acid, itaconic acid, phenylmalonic acid, hydroxyphtalic acid, dihydroxyfumaric acid, tricarballylic acid, benzene-1,3,5-tricarboxylic acid, 1,2,4-benzene tricarboxylic acid, isocitric acid, mucic acid, glucaric acid, succinic acid, glutaric acid, suberic acid, azelaic acid, sebacic acid, decanedicarboxylic acid, isophthalic acid, pimelic acid, brassylic acid, thapsic acid, glutaconic acid, α-hydromuconic acid, [bgr]-hydromuconic acid, a-butyl-a-ethyl-glutaric acid, diethylsuccinic acid, hemimellitic acid, benzophenone tetracarboxylic dianhydride, chlorendic anhydride, hexahydrophthalic anhydride, tetrahydrophthalic anhydride, trimellitic anhydride, alkanyl succinic anhydride, 5-sodiosulfoisophthalic acid, 5-lithiosulfoisophthalic acid, the unsaturated acids and dimerized or trimerized fatty acids, including those found in natural sources such as Borage Oil, Flaxseed oil, and Primrose oil, lactams such as caprolactam, enantholactam, laurolactam, amino acids such as 6-aminocaproic acid, 7-aminoheptanoic acid, 9-aminononanoic acid, 11-aminoundecanoic acid, 12-aminododecanoic acid, and mixtures of two or more thereof.

The dicarboxylic acids may be used either individually or mixed with one another. The free dicarboxylic acids may also be replaced by the corresponding dicarboxylic acid derivatives, for example dicarboxylic acid esters of alcohols having from 1 to 4 carbon atoms or dicarboxylic anhydrides or dicarboxylic acid chlorides.

More examples of polyamines useful in the practice of the invention are those represented by the formula:
H₂N—[—X—NH—]ₙ—H
wherein n is an nominal integer ranging from 1 to 10; and X is a divalent 1-500 carbon atom moiety comprised of a saturated or unsaturated, branched or unbranched hydrocarbon radical, one or more aryl or alkaryl groups, or one or more alicyclic groups. X can be a lower alkylene radical having 1-22, or 2-8, carbon atoms.

Suitable aliphatic polyamines include methylene polyamines, ethylene polyamines, butylene polyamines, propylene polyamines, pentylene polyamines, hexylene polyamines, heptylene polyamines, etc. The higher homologs of such amines and related aminoalkyl-substituted piperazines are also included. More specific examples include ethylene diamine, di(trimethlyene) triamine, diethylene triamine, di(heptamethylene) triamine, triethylene tetramine, tripropylene triamine, tetraethylene pentamine, pentaethylene hexamine, dipropylene triamine, tributylene tetramine, hexamethylene diamine, dihexamethylene triamine, 1,2-propane diamine, 1,3-propane diamine, 1,2-butane diamine, 1,3-butane diamine, 1,4-butane diamine, 1,5-pentane diamine, 1,6-hexane diamine, 2-methyl-1,5-pentanediamine, 2,5-dimethyl-2,5-hexanediamine, octamethlyene diamine, pentaethylene diamine, decamethylene diamine, and the like.

Cycloaliphatic polyamines include isophoronediamine, 4,4′-diaminodicyclohexylmethane, menthane diamine, 1,2-diaminocyclohexane, 1,4-diaminocyclohexane; and aromatic amines such as p- and m-xylylenediamine, 4,4′-methylenedianiline, 2,4-toluenediamine, 2,6-toluenediamine, polymethylene polyphenylpolyamine; 1,3-bis(aminomethyl)benzene, 1,3-phenylenediamine and 3,5-diethyl-2,4-toluenediamine.

Hydroxy polyamines, e.g., alkylene polyamines having one or more hydroxyalkyl substituents on the nitrogen atoms, are also useful in preparing the polyamide polymer of the invention. Examples include hydroxyalkyl-substituted alkylene polyamines in which the hydroxyalkyl group has less than about 10 carbon atoms. Examples of such hydroxyalkyl-substituted polyamines include N-(2-hydroxyethyl)-ethylenediamine, N,N′-bis(2-hydroxyethyl)ethylenediamine, monohydroxypropyl-substituted diethylene triamine, dihydroxypropyltetraethylenepentamine and N-(3-hydroxybutyl) tetramethylenediamine. Higher homologs obtained by condensation of the above-illustrated hydroxyalkyl-substituted alkylene amines through amino radicals or through hydroxy radicals are likewise useful.

Suitable aromatic polyamines include p- and m-xylylene diamine, methylene dianiline, 2,4-toluenediamine, 2,6-toluenediamine, polymethylene polyphenylpolyamine, and mixtures thereof. Higher homologs, obtained by condensing two or more of the above-illustrated alkylene amines, are also useful.

Mixtures of two or more of any of the above mentioned polyamines may be used to react with the polycarboxylic acid. It is to understood that practically any polyamine composition used to react with the polycarboxylic acid will not be 100% pure, and will most likely contain reaction by-products with the identified amine being the predominant compound in the composition. The same can be said for the polycarboxylic acid composition, although a 100% pure composition can be -included as well.

Other groups related to the amide group formed by the reaction between the carboxyl group and the polyamine that are within the meaning of the term amide include the imides and the amidines.

Most preferably, the polyamide polymer contains active methylene groups, such as may be found on benzylic group hydrogens. Such hydrogen atoms may be expressed in the following respective structural moieties as being linked to the carbons illustrated in bold:

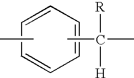

wherein R is a hydrogen or an alkyl group.

The polyamides can be obtained by using synthetic procedures that are well known in the art. Polyamides are generally prepared by melt phase polymerization from a diacid-diamine complex which may be prepared either in situ or in a separate step. In either method, the diacid and diamine are used as starting materials. Alternatively, an ester form of the diacid may be used, preferably the dimethyl ester. If the ester is used, the reaction must be carried out at a relatively low temperature, generally 80 to 120° C., until the ester is converted to an amide. The mixture is then heated to the polymerization temperature. Conventional catalysts may be used to prepare the polyamides of the invention. Such catalysts are described in Principles of Polymerization” 4^{th} ed by George Odian 2004; “Seymour/Carraher's Polymer Chemistry” 6^{th} ed rev and expanded 2003; and “Polymer Synthesis: Theory and Practice” 3^{rd} ed by D. Braun 2001.

Preferred polyamide polymers are those obtained from a reactant containing a benzylic hydrogen. From a viewpoint of their commercial availability, cost, and performance, preferred polyamides are obtained from a reactant containing a a xylylene moiety, or a m-xylylene moiety, or a polymer containing any one of these residues in the polymer chain. More preferred examples include poly(m-xylylene adipamide) modified or unmodified polyamides, and poly(m-xylylene adipamide-co-isophthalamide) modified or unmodified polyamides.

The formulated polyester polymer composition further comprises zinc and cobalt. Zinc and cobalt are effective to activate or promote the oxidation of an oxidizable component, in this case the polyamide polymer. The mechanism by which these transition metals function to activate or promote the oxidation of the polyamide polymer is not certain. For convenience, these transition metals are referred to herein as an oxidation catalysts, but the name does not imply that the mechanism by which these transition metals function is in fact catalytic or follows a catalytic cycle. The transition metal may or may not be consumed in the oxidation reaction, or if consumed, may only be consumed temporarily by converting back to a catalytically active state. As noted in U.S. Pat. No. 5,955,527, incorporated fully herein by reference, a measure of the catalyst may be lost in side reactions, or the catalyst may be viewed as an initiator “generating free radicals which through branching chain reactions leads to the scavenging of oxygen out of proportion to the quantity of “catalyst”.”

The use of the word cobalt includes cobalt in any oxidation state. Examples of cobalt include cobalt added in the +2 or +3 oxidation state, or cobalt metal in the 0 oxidation state. Most preferred is cobalt added in the +2 oxidation state.

In addition to cobalt, zinc is also required as an oxidation catalyst. The word zinc includes zinc in any oxidation state. Formulated polyester polymer compositions containing zinc as a second catalyst exhibit shorter induction periods, or lower oxygen transmission rates, or both, relative to other composition containing the same ingredients but without zinc.

The state of the transition metals is in the +2 or +3 oxidation state, as metal salts. Suitable counter-ions to the metal include carboxylates, such as neodecanoates, octanoates, acetates, lactates, naphthalates, malates, stearates, acetylacetonates, linoleates, oleates, palmitates, 2-ethylhexanoates, or ethylene glycolates; or as their oxides, borates, carbonates, chlorides, dioxides, hydroxides, nitrates, phosphates, sulfates, or silicates among others.

The amount of catalyst in the formulated polyester polymer composition is effective to actively scavenge oxygen. The amount of each metal is expressed in ppm based on the metal, not based on the metal salt as added. The amount of metal may be measured by X-ray fluorescence (X-Ray) or Inductively Coupled Plasma—Mass Spectrometry (ICP).

It is desirable to provide sufficient amounts of cobalt and zinc oxidation catalysts to see significant scavenging effects, and this amount will vary among different transition metals and will also depend upon the degree of scavenging desired or needed in the application. Virgin cobalt is present in a suitable amount, such as an amount ranging from at least 20 ppm, or at least 50 ppm, or at least 60 ppm, and up to about 500 ppm, or up to about 200 ppm, or up to about 150 ppm (by weight of metal), based on the weight of the formulated polyester polymer composition. An amount of virgin cobalt ranging from 50 to 150 ppm imparts good oxygen scavenging activity.

Zinc is present in the formulated polyester polymer composition in a suitable amount, such as an amount ranging from at least 10 ppm, or at least 20 ppm, or at least 40 ppm, and up to about 150 ppm, or up to about 100 ppm or up to about 75 ppm, based on the weight of the formulated polyester polymer composition. The amount of zinc present in a concentrate is much higher on the order ranging from 1000 ppm to 5000 ppm.

Zinc is added at a time and in an amount effective to allow active oxygen scavenging activity to occur in the preform or bottle. Zinc is desirable and preferably added to the melt phase reaction for making a polyester polymer so as to be present as a residual metal when the solid polyester polymer is fed to the melt processing zone (e.g. the extrusion or injection molding zone in contrast with the melt phase reaction for making the polyester polymer) for making the article such as a preform or sheet. In yet another process, zinc may be added in two or more stages, such as once during the melt phase for the production of the polyester polymer and again once more to the melting zone for making the article.

When and how cobalt is added to ultimately make the article is not limited provided that at least a portion of the cobalt present in said molten composition is virgin cobalt. By “virgin” cobalt is meant cobalt which is added after polycondensation is completed and which has not participated in a transesterification reaction. Virgin cobalt is used to ensure that the cobalt is effective to act as an oxidation catalyst to scavenge oxygen and is not by some manner de-activated when present as a polycondensation catalyst to promote building up the molecular weight of a polymer. Preferably, the virgin cobalt is not present in a melt undergoing a transreaction. However, since cobalt is an effective and common polycondensation catalyst, it may be added to the melt phase before or during polycondensation provided that an additional amount of cobalt is also added to the polyester polymer composition after polycondensation. Whether or not cobalt which has seen a polymerization history is present in the molten formulated polyester polymer composition, at least a portion of the overall amount of cobalt present in the melt is virgin cobalt, and the melt containing the virgin cobalt does not undergo an increase in the It.V. of the melt.

Thus, in one embodiment, there is provided a molten formulated polyester polymer composition comprises zinc, cobalt, and a physical blend of a polyester polymer and an oxygen scavenging composition, the oxygen scavenging composition present in an amount ranging from 0.10 wt. % to 10 wt. % based on the combined weight of the polyester polymer and the oxygen scavenging composition, and

(A) said polyester polymer comprising:
(a) a polycarboxylic acid component comprising at least 85 mole % of the residues of terephthalic acid, derivates of terephthalic acid, naphthalene-2,6-dicarboxylic acid, derivatives of naphthalene-2,6-dicarboxylic acid, or mixtures thereof, and
(b) a hydroxyl component comprising at least 50 mole % of the residues of C₂-C₄ aliphatic saturated diols,
based on 100 mole percent of the polycarboxylic acid residues and 100 mole percent hydroxyl residues, respectively, in the polyester polymer; and

(B) said oxygen scavenging composition comprising a polyamide polymer; wherein at least a portion of the cobalt present in said molten composition is virgin cobalt.

We have discovered that when cobalt metal salts are added to the melt phase for making the polyester polymer without also adding cobalt metal salts to the melt processing zone for making a preform, the active oxygen scavenging activity of the resulting stretch blow molded bottle was negligible or non-existent. While this phenomenon is unexplained, it became apparent that when cobalt was added to a melt as a polymerization catalyst, active oxygen scavenging activity suffered. The polymerization catalytic effect of cobalt is evident when the It.V. (an indicator or molecular weight) of a melt of polymers increases. It is acceptable to add cobalt salts to a melt phase reaction as a catalyst to increase the It.V. of the melt so long as an additional amount of cobalt is added to a melt of polymer(s) without increasing the It.V. of the melt. Since many polyester polymers are commercially manufactured with cobalt present as a toner or catalyst each added to a melt phase reaction for polycondensing the melt to increase the molecular weight and It.V. of the melt, this embodiment embraces both blending polyamide polymers with either polyester polymers containing cobalt or polyester polymers which do not contain cobalt, and in either case, adding cobalt to the blend of the polyamide polymer and polyester polymer without increasing the It.V. (molecular weight) of the blend.

In another embodiment, only a portion of the total amount of cobalt present in a formulated polyester composition or in a preform or a bottle is added as virgin cobalt. In other words, a portion of the total amount of cobalt is provided in a polyester polymer and added during polymerization of the polyester polymer, and a portion of the cobalt is added as virgin cobalt.

The cobalt oxidation catalyst may be added neat or in a carrier (such as a liquid or wax) to an extruder or other device for making the article, or it is present in a concentrate or carrier with a polyamide polymer, in a concentrate or carrier with a polyester polymer, or in a concentrate or carrier with a polyester/polyamide blend. Alternatively, cobalt may be added as a polymerization catalyst to the melt phase reaction for making a polyester polymer and present as residual metals when fed to the melting zone (e.g. the extrusion or injection molding zone) for making the article such as a preform or sheet so long as an additional amount of cobalt is also added to the melt processing zone for making the article without increasing the It.V. of the melt in the melt processing zone. Thus, cobalt may be added in two or more stages, such as once during the melt phase for the production of the polyester polymer and again once more to the melting zone for making the article.

In each case, one or both of zinc and cobalt may be added at each stage.

In addition to cobalt and zinc, the formulated polyester polymer composition may contain other metals as esterification, ester exchange, or polycondensation catalysts. In one embodiment, the formulated polyester polymer composition contains antimony, and in an amount of at least 10 ppm, or at least 50 ppm, or at least 100 ppm, or at least 150 ppm, and up to any amount desired, although more than about 300 ppm is not needed. While antimony is typically added as an antimony carboxylic acid salt, it may be reduced in the melt phase in situ by the addition of phosphorus compounds to the melt phase, typically during the later half of polycondensation. Suitable ratios of phosphorus atoms to antimony and zinc atoms ranges from 0.025(P):1(Zn+Co) to 5.0(P):1(Zn+Co).

A polyester polymer composition can be made as a precursor product or a solid state polymerized product. Such a composition is not yet fully formulated either by the absence of or insufficient amount of oxidation catalyst metals or polyamide polymer. In this case, the polyester polymer composition is fed to a melt processing zone for making the article (e.g. extruder or injection molding machine) along with the desired amount of oxidation catalyst(s), the polyamide polymer, or both.

In yet a further alternative embodiment, a formulated polyester polymer composition is provided and fed to a melt processing zone for making the article, and while the amounts of oxidation catalysts and polyamide polymer are sufficient, the converter desires to optimize the amounts for a particular application, and therefore may add more oxidation catalyst, polyamide polymer, or both to the formulated polyester polymer composition.

The following methods are useful to make a formulated polyester polymer composition:

(i) both zinc and cobalt compounds are added during melt phase manufacture of the polyester polymer particles which are optionally solid state polymerized, and the polyamide polymer and additional amounts of at least cobalt or both of oxidation catalysts are added to the melt processing zone together polyester polymer particles to provide a formulated polyester polymer composition with the desired levels of oxidation catalysts, or

(ii) a zinc compound is added during the melt phase manufacture of the polyester polymer particles which are optionally solid state polymerized, and the polyamide polymer and cobalt compounds are added together or separately to the melt processing zone together with the polyester polymer particles to provide a formulated polyester polymer composition with the desired levels of oxidation catalysts, or

(iii) a salt and pepper blend of polyamide pellets and polyester polymer pellets, one or both optionally ground, and either one or both containing the oxidation catalysts, can be prepared and then fed as a pelletpellet blend to melt processing zone for making the article, provided that if cobalt is present in the pellets and added during the melt phase manufacturing of the pellet in which the molecular weight of the polymer was increased in the presence of cobalt, additional amounts of cobalt are added.

In each case, the oxidation catalyst(s) and the polyamide polymer may be added to the melt processing zone neat, in a liquid carrier, or as a concentrate, and added together in one combined stream or in separate streams. A concentrate or carrier containing both the polyamide polymer and one or both of the oxidation catalysts can be let down to a stream or molten stream of polyester polymer fed to or in a melt processing zone at a rate corresponding to the final desired concentration of catalysts and polyamide polymer in the article.

In a more preferred embodiment, there is provided a polyester polymer composition containing zinc and cobalt and lacking a polyamide polymer, feeding the polyester polymer composition to a melt processing zone for making an article together with a polyamide polymer and additional cobalt to form a melt comprising a formulated polyester polymer composition, and forming an article from the melt.

There is also provided a process for making an article, comprising:

(1) combining a polyester polymer and an oxygen scavenging composition comprising a polyamide in the presence of zinc and a cobalt in a melt processing zone to form a melt; and

(2) forming an article such as a sheet or preform directly from the melt.

In this latter embodiment, the polyester polymer and the oxygen scavenging composition such as a polyamide may transreact to form a copolymer in the melt or may reside in the melt as a blend, and in either case, the melt is extruded or injection molded to form an article such as a preform or sheet, preferably a preform, directly from the melt. (e.g. is not first pelletized and then remelted). Most desirable is to provide melt processing zone conditions effective to retain the polyester polymer and the oxygen scavenging compound as a physical blend in the melt. Such melt processing zone conditions are described further below and it is presumed for purposes of the invention that a physical blend is present if the ingredients are processed under such conditions even if minor amounts of transesterification occur.

While the above embodiments have been described with reference to the composition of a melt, and with reference to methods for the addition of cobalt and zinc to a melt, there is also provided other embodiments comprising solid pellets or articles such as sheets, preforms, bottles, trays, and other articles mentioned further below, which posses zinc and cobalt along with a blend of the stated polyester and polyamide polymers as described above. In preferred embodiments, these solid pellets and articles have low rates of oxygen transmission.

The melt processing zone for making the article is operated under customary conditions effective for making the intended articles, such as preforms, bottles, trays, and other articles mentioned below. In one embodiment, such conditions are effective to process the melt without increasing the It.V. of the melt and which are ineffective to promote transesterification reactions. While the It.V. of the raw materials may differ, once blended and molten, the It.V. of the melt desirably does not increase. Suitable operating conditions effective to establish a physical blend of the polyester polymer and oxygen scavenging compounds are temperatures in the melt processing zone within a range of 250° C. to 300° C. at a total cycle time of less than 6 minutes, and typically without the application of vacuum and under a positive pressure ranging from 00 psig to 900 psig. The residence time of the melt on the screw can range from about 1-4 minutes.

The rate of oxygen transmission and the length of the induction period is significantly reduced when using zinc as an additional oxygen scavenging catalyst relative to other compositions which contain the same type and amount of polyamide without zinc. The formulated polyester polymer composition of the invention now provides flexibility in the choice of polyamide polymers while providing short induction periods, low oxygen transmission rates, and good capacity for oxygen scavenging through the life of many filled packages (e.g. at least 6 months or more). While low molecular weight polyamide polymers may be used, or polyamide polymers whose terminal groups are predominately acid or hydrocarbyl capped, packages can now be made with other polyamide polymers having higher molecular weights and with a variety of end group types, end group ratios, and end group concentrations, while providing short induction periods and low oxygen transmission rates. Moreover, while other polymer compositions made with antimony and cobalt can provide a measure of oxygen scavenging, the antimony, cobalt, zinc combinations described herein provide the same measure or better oxygen scavenging with lower amounts of polyamide polymer. The formulated polyester polymer composition has good oxygen scavenging performance while providing the added flexibility to use small amounts of polyamide polymer and thereby reduce the level of haze in the bottles manufactured from the composition. In clear bottle applications, achieving technically superior oxygen scavenging is of little value if the amount of polyamide that must be added to the composition creates a high level of haze in the bottle.

The oxygen transmission rate (“OTR”) of bottles made with the formulated polyester polymer compositions of the invention are as low as 0.020 cc STP/day or less, preferably do not exceed 0.010 cc STP/day, and even do not exceed 0.005 cc/day for a continuous period of at least 50 days measured at any time within a period after the manufacture of the container and before 100 days after its manufacture. The OTR is expressed in the unit of cc STP/day, where STP is 273° K. and 1 atm, and tested according to the method described below at 23° C., 50% relative humidity (r.h.) external to the package, and about 80% r.h. internal. Preferably, the 50 day continuous period begins within 35 days after blow molding the polyester container, or begins within 15 days after making the blow molded container, thereby combining both the element of short induction periods and low oxygen transmission rates.

In another embodiment, there is provided a blow molded polyester bottle having an oxygen transmission rate of 0.020 cc/day STP or less, more preferably 0.010 cc/day or less, for a continuous period of 40 days at any time within a period commencing from bottle manufacture and 100 days thereafter, preferably 80 days thereafter, wherein the bottle comprises zinc, cobalt, and a physical blend of the polyamide polymer and a polyester polymer.

The formulated polyester polymer composition of the invention is also capable of actively scavenging oxygen to reduce the oxygen transmission rate to a low and sustainably low level for a lengthy period of time. The containers made with the formulated polyester polymer composition are capable of continuously sustaining oxygen transmission rates at less than 0.020 cc/day, preferably 0.010 cc/day or less, and even 0.005 cc/day or less for a continuous period of at least 100 days, or at least 160 days, and even for at least 365 days.

The oxygen transmission rate test is performed using stretch blow molded bottles. The bottles are fitted following blow molding for oxygen package transmission testing. Prior to measurement, the bottle is sealed by gluing it to a brass plate that is connected to a 4 way valve over the finish. This mounting technique seals the bottle, while allowing for control of test gas access. The mounting is assembled as follows. First a brass plate is prepared by drilling two ⅛ inch holes into the plate. Two lengths of ⅛ soft copper tubing (which will be designated A and B) are passed through the holes in the plate and the gaps between the holes and the tubes are sealed with epoxy glue. One end of each of these tubes is attached to the appropriate ports on a 4-way ball valve (such as Whitey model B-43YF2). Tubing (which will be designated C and D) and connections are also attached to the other ports of the ball valve to allow the finished assembly to be connected to an Oxtran oxygen permeability tester (Modern Control, Inc. Minneapolis, Minn.).

This mounting is then glued to the finish of the bottle to be tested so that tubes A and B extend into the interior of the bottle. The open end of one tube is positioned near the top of the package and the open end of the other is positioned near the bottom to ensure good circulation of the test gas within the bottle. Gluing is typically performed in two steps using a quick setting epoxy to make the initial seal and temporarily hold the assembly together and then a second coating of a more rugged Metalset epoxy is applied. If desired the brass plate may be sanded before mounting to clean the surface and improve adhesion. If the 4 tubes are correctly connected to the 4-way valve, then when the valve is in the “Bypass” position, tubes A and B communicate and tubes C and D communicate, but tubes A and B do not communicate with tubes C and D. Thus the package is sealed. Similarly, when the valve is in its “Insert” position, tubes A and D communicate and tubes B and C communicate, but A and D do not communicate with tubes B and C, except through the interior of the bottle. Thus the bottle can be swept with purge or test gas.

Once the bottle is mounted on the assembly, it is swept with an oxygen-free gas, and the conditioning period begins. After several minutes of purging, the 4-way valve is moved to the Bypass position, sealing the bottle. At that point the entire bottle and mounting assembly may be disconnected from the purge gas supply without introducing oxygen into the interior of the bottle. Typically 2 or 3 bottles of each formulation were mounted for testing.

When the oxygen transmission rate of the bottle is to be tested, it is placed inside an environmental chamber. Under normal operation these chambers control the external conditions at 23° C. plus or minus 1° C. and 50% relative humidity plus or minus 10%. These chambers contain tubing connections to an Oxtran 1050 or Oxtran 1050A instrument and the mounting is connected to the Oxtran tester via tubes C and D. Carrier gas (nitrogen containing on the order of 1% hydrogen), which is humidified using a bubbler, is supplied to the instruments and the tubing in the environmental chamber. Both the Oxtran 1050 and 1050A use a coulometric sensor to measure oxygen transmission rates and both have positions for 10 samples to be mounted on the instrument at one time. Typically, 9 test bottles and 1 control package were run in a set. Once samples were mounted in the chamber, the 4-way valve is turned to the Insert position and the system is allowed to recover from the perturbation caused by this process.

After allowing the system to recover, the test is then begun by “inserting” the instrument sensor in-line. The test sequence is controlled by a specially written LabView™ software interface for the instrument. Basically, the instrument automatically advances through the test cells using a preset interval that allows the instrument to stabilize after each cell change as the test gas from the bottle mounted on the cell is routed through the coulemtric sensor, generating a current. That current is passed through a resistor, which creates a voltage that is proportional to the oxygen transmission rate of the package plus the leak rate of that cell and package assembly. Typically the instrument is allowed to index through each of the cells 3 or more times and the average of the last 3 measurements is used. Once these readings are obtained, the 4-way valves are moved to their Bypass positions and this process is repeated, providing a measure of the leak rate for the cell and assembly. This value is subtracted from the value obtained for the package, cell and assembly to yield the value for the package. This value is corrected for the average barometric pressure in the laboratory and reported as the oxygen transmission rate (OTR) of the bottle (in cc(STP) of oxygen/day). At this point the test is terminated and the bottles are removed from the instrument (with the 4-way valves still in the Bypass position).

Between tests, bottles are stored at ambient (RH, lighting, barometric pressure) conditions in a lab (22° C. plus or minus 4° C.) with the interior isolated from air. After a period of time, the bottle is reconnected to the Oxtran and a new set of transmission measurements collected. In this manner, it is possible to monitor the behavior of the bottle over several weeks or months.

The formulated polyester polymer composition of the invention also includes those composition made into various articles, such as found in moldings of all types by injection molding, extrusion, and for making thermoformed articles.

Specific articles include preforms, containers and films for packaging of food, beverages, cosmetics, pharmaceuticals, and personal care products where a high oxygen barrier is needed. Examples of beverage containers are bottles for holding water and carbonated soft drinks, and the invention is particularly useful in bottle applications containing juices, sport drinks, beer or any other beverage where oxygen detrimentally affects the flavor, fragrance, performance (e.g. oxidative vitamin degradation), or color of the drink. The polymer blends are also particularly useful as a sheet for thermoforming into rigid packages and films for flexible structures. Rigid packages include food trays and lids. Examples of food tray applications include dual ovenable food trays, or cold storage food trays, both in the base container and in the lidding (whether a thermoformed lid or a film), where the freshness of the food contents can decay with the ingress of oxygen. The polymer blends also find use in the manufacture of cosmetic containers and containers for pharmaceuticals or medical devices.

The bottles, sheets, and preforms made from the composition of the invention may be monolayer or multilayered, made by stretch or extrusion blow molding. The cost of monolayer preforms and bottles and trays is less than multilayered structures. If desired, however, there is also provided a multilayered preform, extruded sheet product, thermoformed sheet product, extrusion blow molded product, stretch blow molded product, or bottle containing more than one layer, e.g. 2-5 layers, wherein at least one of the layers comprises the composition of the invention.

Many other ingredients can be added to the compositions of the present invention to enhance the performance properties of the blends. For example, crystallization aids, reheat enhancers, impact modifiers, surface lubricants, denesting agents, stabilizers, ultraviolet light absorbing agents, metal deactivators, toners or dyes, inorganic colorants such as titanium dioxide and carbon black, nucleating agents such as polyethylene and polypropylene, phosphate stabilizers, fillers, and the like, can be included herein. All of these additives and the use thereof are well known in the art and do not require extensive discussions. Therefore, only a limited number will be referred to, it being understood that any of these compounds can be used so long as they do not hinder the present invention from accomplishing its objects.

A common additive used in the manufacture of polyester polymer compositions used to make stretch blow molded bottles is a reheat additive since the preforms made from the composition must be reheated prior to entering the mold for stretch blowing into a bottle. Any of the conventional reheat additives can be used, such as the various forms of black particles, e.g. carbon black, activated carbon, black iron oxide, glassy carbon, and silicon carbide; the gray particles such as antimony, and other reheat additives such as silicas, red iron oxide, and so forth.

Other typical additives, depending on the application, also include impact modifiers. Examples of typical commercially available impact modifiers well-known in the art and useful in this invention include ethylene/acrylate/glycidyl terpolymers and ethylene/acrylate copolymers in which the acrylate is a methyl or ethyl acrylate or methyl or ethyl methacrylate or the corresponding butyl acrylates, styrene based block copolymers, and various acrylic core/shell type impact modifiers. The impact modifiers may be used in conventional amounts from 0.1 to 25 weight percent of the overall composition and preferably in amounts from 0.1 to 10 weight percent of the composition.

In many applications, not only are the packaging contents sensitive to the ingress of oxygen, but the contents may also be affected by uv light, especially with fruit juices and pharmaceuticals. Accordingly, may also be desirable to incorporate into the polyester composition any one of the known uv absorbing compounds in amounts effective to protect the packaged contents.

The following examples illustrate one or more of the embodiments of the invention and are not limiting on the scope of the invention.

### EXAMPLES

Below is a listing of the base Resin polymers used in each example. The final formulation of each example may differ from example to example even though the same Resin was used because additional or different additives or catalysts may be added to the same base Resin. For this reason, additional catalysts or additives present in an example are set forth in Tables describing in greater detail the formulation of the example.

Resin 1: About a 0.85 It.V. polyester polymer composition containing residues of dimethyl terephthalate, ethylene glycol, and cyclohexane dimethanol, with cyclohexane dimethanol residues representing about 1.8 mol % of the glycol residues, with about 60 to 65 ppm Zn and about 220 to 230 ppm Sb as catalysts, about 65 to 75 ppm phosphorous, and containing Fe, UV dye, and red and blue toners.

Resin 2: About a 0.83 It.V. polyester polymer composition containing residues of dimethyl terephthalate, ethylene glycol, and cyclohexane dimethanol, with cyclohexane dimethanol residues representing about 1.8 mol % of the glycol residues, with about 60 to 65 ppm Zn and about 220 to 230 ppm Sb as catalysts, about 65 to 75 ppm phosphorous, containing Fe, UV dye, and red and blue toners.

Resin 3: About a 0.83 It.V. polyester polymer composition containing residues of dimethyl terephthalate, ethylene glycol, and cyclohexane dimethanol, with cyclohexane dimethanol residues representing about 1.8 mol % of the glycol residues, with about 60 to 65 ppm Zn and about 220 to 230 ppm Sb as catalysts, about 65 to 75 ppm phosphorous, and containing Fe, UV dye, and red and blue toners.

Resin 4: About a 0.81 It.V. polyester polymer composition containing residues of dimethyl terephthalate, ethylene glycol, and cyclohexane dimethanol, with cyclohexane dimethanol residues representing about 1.8 mol % of the glycol residues, with about 60 to 65 ppm Zn and about 220 to 230 Sb as catalysts, about 65 to 75 ppm phosphorous, and containing Fe, UV dye, and red and blue toners.

Resin 5: About a 0.78 It.V. polyester polymer composition containing residues of dimethyl terephthalate, ethylene glycol, and cyclohexane dimethanol, with cyclohexane dimethanol residues representing about 1.8 mol % of the glycol residues with about 60 to 65 ppm Zn and about 220 to 230 ppm Sb as catalysts, about 65 to 75 ppm phosphorous, and containing Fe, UV dye, and red and blue toners.

Resin 6: About a 0.87 It.V. polyester polymer composition containing residues of dimethyl terephthalate, ethylene glycol, and cyclohexane dimethanol, with cyclohexane dimethanol residues representing about 1.8 mol % of the glycol residues, with about 20 ppm Ti, about 55 ppm Mn and about 230 to 255 Sb as catalysts, about 85 to 95 ppm phosphorous, and containing Fe, UV dye, and red and blue toners.

Resin 7: About a 0.81 It.V. polyester polymer composition containing residues of terephthalic acid, isophthalic acid and ethylene glycol with isophthalic acid residues representing about 2 mole % of the acid residues, Sb in an amount of about 235 to 255 ppm, phosphorus in an amount of about 25 to 35 ppm, and from about 25 to 30 ppm Co.

Resin 8: About a 0.76 ItV polyester polymer composition containing residues of dimethyl terephthalate, ethylene glycol and cyclohexane dimethanol with cyclohexane dimethanol residues representing about 1.8 mole % of the glycol residues, Sb in an amount of about 215 to 230 ppm, phosphorous in amount of about 55 to 65 ppm and Zn in an amount of about 60 to 65 ppm, and red and blue toners.

Resin 9: About a 0.84 ItV polyester polymer composition containing residues of terephthalic acid, isophthalic acid and ethylene glycol with isophthalic acid residues representing about 2 mole % of the acid residues, Sb in an amount of about 235 to 250 ppm, phosphorus in an amount of about 25 to 35 ppm, and red and blue toners.

Resin 10: About a 0.87 ItV polyester polymer composition containing residues of dimethyl terephthalate and ethylene glycol, Sb in an amount of about 235 to 245 ppm, phosphorous in amount of about 60 to 70 ppm and Zn in an amount of about 60 to 65 ppm.

Resin 11: About a 0.84 ItV polyester polymer composition containing residues of dimethyl terephthalate, ethylene glycol and dimethyl isophthalate with dimethyl isophthalate residues representing about 2 mole % of the acid residues, Sb in an amount of about 240 to 250 ppm, phosphorous in amount of about 55 to 65 ppm and Zn in an amount of about 60 to 65 ppm.

Resin 12: About a 0.78 ItV polyester polymer composition containing residues of dimethyl terephthalate and ethylene glycol, Sb in an amount of about 240 to 250 ppm, phosphorous in amount of about 80 to 900 ppm, Zn in an amount of about 60 to 65 ppm, and cobalt in an amount of 55 to 65 ppm.

Resin 13: About a 0.71 ItV polyester polymer composition containing residues of dimethyl terephthalate, ethylene glycol and dimethyl isophthalate with dimethyl isophthalate residues representing about 2 mole % of the acid residues, Sb in an amount of about 250 to 260 ppm, phosphorous in amount of about 80 to 90 ppm, Zn in an amount of about 60 to 65 ppm and cobalt in an amount of 60 to 90 ppm.

Resin 14: About a 0.76 ItV polyester polymer composition containing residues of dimethyl terephthalate, ethylene glycol and dimethyl isophthalate with dimethyl isophthalate residues representing about 2 mole % of the acid residues, Sb in an amount of about 260 to 270 ppm, phosphorous in amount of about 90 to 100 ppm, Zn in an amount of about 60 to 65 ppm and cobalt in an amount of 60 to 70 ppm.

It should be understood that the glycol portion of each of the PET resins also contains low levels (less than 5 mol %) DEG residues, which is present as a natural byproduct of the melt polymerization process and may also be intentionally added as a modifier.

Concentrate: is a solid concentrate containing about 3500 ppm cobalt prepared using 22.5% TEN-CEM cobalt (which is believed to be predominately cobalt neodecanoate), in a solid polyethylene terephthalate polymer 9921 available from Eastman Chemical Company.

Polyamide Polymer A: is poly(m-xylylene adipamide) commercially available as MXD-6™ 6007 from Mitsubishi Gas, having an number average molecular weight of 23000 as calculated below, a terminal carboxyl group concentration of 0.066 meq/gm and a terminal amine group concentration of 0.021 meq/gm.

Polyamide Polymer B: is poly(m-xylylene adipamide) commercially available as MXD-6™ 6121 from Mitsubishi Gas, having a number average molecular weight of 37000 as calculated below, a terminal carboxyl group concentration of 0.038 meq/gm and a terminal amine group concentration of 0.016 meq/gm.

The method used to measure the terminal carboxyl group concentration is potentiometric titration. One gram of polyamide is placed in 50 milliliters of benzyl alcohol and heated until dissolved. The titrant is 0.01 N potassium hydroxide in isopropanol.

Terminal amine group concentration is determined by potentiometric titration. One gram of polyamide is dissolved in 90 mis of m-cresol at 25° C. The titrant is 0.01 N perchloric acid in a ratio of 2:1 isopropanol/propylene glycol. The titrant is prepared from 70% perchloric acid in water.

Mn is estimated by using following relationship:
Mn=2*1000/(meq carboxyl/gm+meq amino/gm).

Copolyester: is a copolyester commercially available as Amosorb® DFC commercially available from BP Amoco at the time (now believed to be sold through Colour Matrix), believed to be a copolymer of about 5 to 10 volume % hydroxyl terminated polybutadiene with polyethylene terephthalate containing cobalt as an oxidation catalyst in an amount ranging from 1000 ppm to 1500 ppm and less than 5 ppm zinc.

### Experiment 1

Preforms were molded on a Husky LX160PET P60/50 E42 machine using an 8 cavity, 25 gram preform tooling. Blends were prepared by mixing solid pellets of the respective materials in the amounts identified in Table 2 after drying and prior to addition to the molding machine hopper. Processing conditions are standard molding conditions and include barrel and manifold temperature settings of 280° C. (536° F.). The remaining injection molding conditions are given below in Table 1.

TABLE 1

| Machine Parameter | Setting |
|---|---|
| Nozzle Tip (%) | 40 |
| Sprue Bushing (%) | 10 |
| Fill Time (sec) | 2.64 |
| Hold Time (sec) | 6.5 |
| Cooling Time (sec) | 3.5 |
| Screw Speed (rpm) | 61 |
| Back Pressure (psi) | 136 |
| Transfer Time (sec) | 1.9 |
| Recovery/Dead Time (sec) | 2.75 |
| Cycle Time (sec) | 17.95 |

The preforms made from each of the resins and additives described above were tested by X-ray fluorescence to measure the average ppm of metals present in the preforms. The average ppm levels of metals were based on measurements taken from three preform samples. The results are reported below in Table 2. The amount of polyamide polymer and copolyester are also reported in Table 2.

Cobalt was not added during the polymerization of resins 1, 2, 3, 4 and 5 in the melt, so the cobalt levels shown in Table 2 represent virgin cobalt added via the concentrate.

TABLE 2

| | | | | Polyamide | | | | | |
|---|---|---|---|---|---|---|---|---|---|
| | | Resin | Concentrate | Polymer A | Copolyester | | | | |
| | Resin | Amount | Amount | Amount | Amount | X-Ray Metals (avg ppm) | | | |
| Example # | Type | (lbs) | (gms) | (gms) | (gms) | Co | P | Sb | Zn |
| Comparative 1 | Resin 5 | 50 | 0 | 0 | 0 | 0 | 69 | 221 | 60-65 |
| Comparative 2 | Resin 5 | 30 | 0 | 0 | 421 | 30 | 67 | 218 | 60-65 |
| 3 | Resin 5 | 28.2 | 408 | 408 | 0 | 95 | 81 | 208 | 60-65 |
| Comparative 4 | Resin 1 | 30 | 0 | 0 | 421 | 26 | 67 | 211 | 60-65 |
| Comparative 5 | Resin 2 | 30 | 0 | 0 | 421 | 29 | 68 | 218 | 60-65 |
| 6 | Resin 3 | 28.2 | 408 | 408 | 0 | 86 | 80 | 218 | 60-65 |
| 7 | Resin 4 | 28.2 | 408 | 408 | 0 | 93 | 80 | 219 | 60-65 |
| Comparative | Resin 6 | 28.2 | 408 | 408 | 0 | 101 | 98 | 235 | None |
| 8* | | | | | | | | | |

*Also containing 20 ppm Ti and 54 ppm Mn

Once the preforms were made, each were biaxially stretch blow molded into 20 oz. straight wall bottles using a Sidel SBO2/3 reheat blow molding machine. Bottle blowing conditions were adjusted to give samples with similar distribution of material thought the bottle. Bottles were mounted using the procedure as described above and the interiors were purged with oxygen free gas one day after blowing.

The oxygen transmission rate (OTR) results from the bottles are reported in Table 3. The OTR results were obtained by the OTR test method described above.

TABLE 3

| | Comp. 1 | | Comp. 2 | | Comp. 4 | | Comp. 5 | | Comp 8 | | Ex. 3 | | Ex. 6 | | Ex. 7 | |
|---|---|---|---|---|---|---|---|---|---|---|---|---|---|---|---|---|
| Day | OTR | # | OTR | # | OTR | # | OTR | # | OTR | # | OTR | # | OTR | # | OTR | # |
| 4 | | | 0.0014 | 1 | 0.0014 | 1 | 0.0015 | 1 | 0.0346 | 3 | 0.0016 | 1 | 0.0012 | 3 | 0.0012 | 2 |
| 4 | | | | | 0.0014 | 3 | | | | | 0.0012 | 2 | 0.0014 | 1 | 0.0017 | 1 |
| 4 | | | | | | | | | | | | | 0.0011 | 2 | | |
| 8 | | | 0.0021 | 3 | | | 0.0016 | 2 | 0.0323 | 2 | 0.0010 | 3 | | | 0.0012 | 3 |
| 8 | | | | | | | | | 0.0327 | 1 | | | | | | |
| 11 | | | | | | | | | 0.0283 | 1 | | | | | | |
| 11 | | | | | | | | | 0.0237 | 2 | | | | | | |
| 14 | | | | | | | | | 0.0256 | 1 | | | | | | |
| 14 | | | | | | | | | 0.0193 | 2 | | | | | | |
| 17 | | | | | | | | | 0.0142 | 3 | | | | | | |
| 18 | | | | | | | 0.0010 | 3 | 0.0194 | 1 | | | | | | |
| 20 | | | | | | | 0.0005 | 2 | 0.0083 | 3 | 0.0004 | 3 | 0.0003 | 3 | 0.0008 | 1 |
| 20 | | | 0.0006 | 3 | 0.0011 | 1 | | | | | | | | | | |
| 21 | | | | | | | | | 0.0146 | 2 | | | | | | |
| 24 | | | | | | | | | 0.0059 | 3 | | | | | | |
| 24 | | | | | | | | | 0.0113 | 2 | | | | | | |
| 24 | | | | | | | | | 0.0174 | 1 | | | | | | |
| 29 | | | | | | | | | 0.0038 | 1 | | | | | | |
| 29 | | | | | | | | | 0.0082 | 3 | | | | | | |
| 29 | | | | | | | | | 0.0107 | 2 | | | | | | |
| 36 | | | | | | | | | 0.0064 | 1 | | | | | | |
| 36 | | | | | | | | | 0.0051 | 2 | | | | | | |
| 38 | | | | | | | | | 0.0054 | 1 | | | | | | |
| 38 | | | | | | | | | 0.0043 | 2 | | | | | | |
| 40 | | | 0.0012 | 3 | 0.0029 | 3 | 0.0019 | 1 | 0.0037 | 1 | 0.0003 | 1 | 0.0007 | 2 | 0.0006 | 2 |
| 40 | | | | | | | | | 0.0031 | 2 | | | | | | |
| 40 | | | | | | | | | 0.0018 | 3 | | | | | | |
| 42 | | | 0.0014 | 1 | 0.0038 | 1 | 0.0029 | 3 | 0.0029 | 1 | | | | | | |
| 42 | | | | | 0.0049 | 3 | 0.0023 | 2 | | | | | | | | |
| 43 | 0.0572 | 3 | | | | | | | | | | | | | | |
| 43 | 0.0545 | 1 | | | | | | | | | | | | | | |
| 50 | | | | | 0.0065 | 3 | 0.0039 | 2 | 0.0017 | 1 | | | | | | |
| 53 | 0.0528 | 3 | 0.0032 | 1 | 0.0061 | 1 | 0.0036 | 1 | 0.0012 | 2 | 0.0005 | 1 | 0.0003 | 2 | 0.0005 | 2 |
| 59 | | | 0.0038 | 3 | 0.0046 | 2 | 0.0077 | 3 | 0.0006 | 3 | | | | | | |
| 59 | | | | | | | | | 0.0005 | 1 | 0.0004 | 1 | 0.0012 | 1 | 0.0002 | 3 |
| 66 | 0.0510 | 2 | | | | | | | | | | | | | | |
| 66 | 0.0508 | 1 | | | | | | | | | | | | | | |
| 70 | | | 0.0061 | 3 | 0.0061 | 2 | 0.0120 | 3 | 0.0007 | 1 | 0.0010 | 1 | 0.0010 | 1 | 0.0003 | 3 |
| 80 | | | 0.0089 | 3 | 0.0135 | 1 | 0.0089 | 1 | 0.0013 | 1 | | | | | | |
| 89 | | | 0.0123 | 1 | 0.0178 | 3 | 0.0116 | 1 | 0.0004 | 2 | 0.0004 | 2 | 0.0006 | 1 | 0.0002 | 2 |
| 89 | | | | | | | | | 0.0007 | 3 | | | | | | |
| 96 | | | 0.0150 | 3 | 0.0140 | 2 | 0.0201 | 2 | 0.0004 | 1 | 0.0006 | 2 | 0.0004 | 2 | 0.0004 | 3 |
| 96 | | | | | 0.0214 | 1 | | | | | | | | | | |
| 102 | | | 0.0267 | 2 | 0.0247 | 3 | 0.0172 | 1 | −1.0013 | 2 | 0.0003 | 3 | 0.0006 | 1 | 0.0007 | 1 |
| 110 | | | | | 0.0175 | 2 | | | 0.0004 | 1 | 0.0004 | 1 | | | | |
| 119 | | | 0.0220 | 3 | 0.0299 | 1 | 0.0287 | 2 | 0.0006 | 3 | 0.0005 | 2 | 0.0004 | 2 | 0.0003 | 3 |
| 126 | | | | | | | | | 0.0003 | 2 | | | | | | |
| 126 | | | | | | | | | 0.0006 | 1 | | | | | | |
| 137 | | | 0.0315 | 3 | 0.0274 | 2 | 0.0351 | 3 | 0.0014 | 2 | 0.0024 | 1 | 0.0007 | 1 | 0.0003 | 2 |
| 137 | | | | | | | 0.0336 | 2 | | | | | | | | |
| 150 | | | 0.0388 | 2 | 0.0321 | 1 | 0.0291 | 1 | 0.0012 | 1 | 0.0003 | 3 | 0.0004 | 2 | 0.0003 | 3 |
| 174 | | | 0.0360 | 1 | 0.0365 | 3 | 0.0351 | 1 | 0.0007 | 3 | 0.0002 | 3 | 0.0004 | 2 | 0.0003 | 1 |
| 174 | | | | | | | | | −0.0016 | 1 | | | | | | |
| 178 | 0.0517 | 1 | | | | | | | | | | | | | | |
| 178 | 0.0538 | 3 | | | | | | | | | | | | | | |
| 178 | 0.0522 | 2 | | | | | | | | | | | | | | |
| 194 | | | 0.0381 | 2 | 0.0364 | 1 | 0.0356 | 2 | 0.0008 | 1 | 0.0006 | 1 | 0.0008 | 1 | 0.0003 | 3 |
| 208 | | | | | | | | | 0.0005 | 2 | | | | | | |
| 211 | | | 0.0370 | 3 | 0.0351 | 2 | 0.0381 | 3 | 0.0003 | 3 | 0.0005 | 2 | 0.0006 | 2 | 0.0005 | 3 |
| 215 | | | | | | | | | 0.0005 | 1 | | | | | | |
| 222 | | | 0.0402 | 1 | | | 0.0377 | 1 | | | | | | | | |
| 246 | | | | | | | | | 0.0008 | 1 | 0.0006 | 1 | 0.0009 | 1 | 0.0011 | 1 |
| 253 | | | 0.0363 | 2 | | | | | −0.0004 | 2 | 0.0009 | 3 | | | | |
| 260 | | | | | 0.0417 | 3 | 0.0413 | 2 | 0.0008 | 1 | | | 0.0012 | 2 | 0.0007 | 2 |
| 283 | | | 0.0429 | 3 | | | | | 0.0008 | 3 | 0.0006 | 2 | | | | |
| 293 | | | | | | | | | 0.0017 | 1 | | | | | | |
| 316 | | | 0.0447 | 1 | | | | | 0.0007 | 2 | 0.0006 | 1 | | | | |
| 321 | | | | | | | | | 0.0012 | 1 | | | 0.0011 | 1 | 0.0022 | 1 |
| 330 | 0.0458 | 3 | | | | | | | | | 0.0022 | 2 | | | | |
| 330 | 0.0451 | 1 | | | | | | | | | | | | | | |
| 334 | 0.0494 | 3 | | | | | | | | | | | | | | |
| 344 | | | | | | | | | 0.0045 | 2 | | | | | | |
| 345 | | | 0.0399 | 2 | | | | | | | | | | | | |
| 353 | | | | | | | | | 0.0040 | 1 | | | | | | |
| 360 | | | | | | | | | | | 0.0005 | 1 | | | | |
| 397 | | | | | | | | | 0.0082 | 2 | 0.0020 | 2 | | | | |
| 424 | | | | | | | | | 0.0078 | 1 | 0.00069 | 1 | 0.0037 | 2 | 0.0033 | 2 |

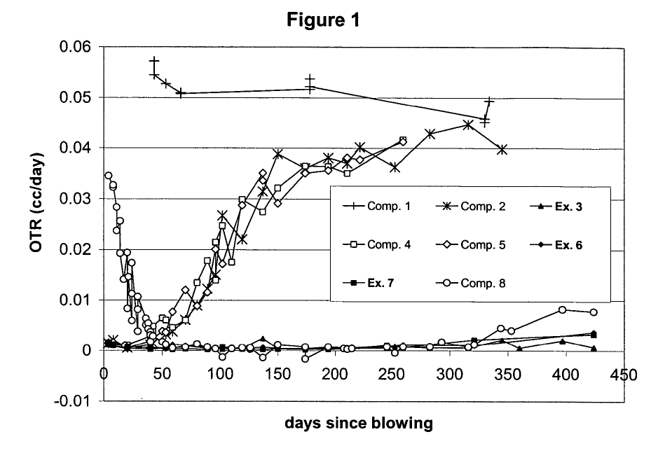

FIG. 1 is a graph of the data set forth in Table 3 within a limited time frame to illustrate the relative differences in the oxygen transmission rate into bottles over time made from the Resins and compositions described in Table 2. The graph illustrates the differences in OTR between compositions of the invention compared to compositions that either do not contain zinc or made without a polyamide polymer.

Comparative Example 1, with no oxygen scavenging compounds, lacked any oxygen scavenging activity. When the same polyester resin containing zinc was combined with cobalt and an oxygen scavenging compound other than a polyamide compound (a Copolyester) was used such as in Comparative Example 2, the OTR was initially low for the first 30-40 days, but thereafter the oxygen scavenging capacity rapidly deteriorated and the OTR increased significantly from day 60 through 200. When the same resin containing zinc was combined with a Polyamide and cobalt, as in Example 3, the oxygen scavenging activity was excellent both in the shortness of the induction period (virtually no induction period) and the capacity of the oxygen scavenging activity remaining below 0.005 cc STP/day over a period of 200 days. Comparative Example 8 demonstrates that the induction period of a bottle made with virgin cobalt, a Polyamide polymer oxygen scavenger, but devoid of zinc, was longer than the induction periods of Examples 3, 6, and 7 which each contained zinc, and its capacity was also not as good over a lengthy period of time beyond 350 days.

The performance of the polyester composition made with the Copolyester as the oxygen scavenging compound remained generally unaffected by differences in catalyst concentration.

The oxygen transmission rates of polyester resin compositions containing a polyamide, comparable amounts of cobalt as the oxidation catalyst, and also zinc, as in Examples 3, 6, and 7 were excellent in that they exhibited short induction periods, low OTR, and good capacity extending out beyond 200 days.

### Experiment 2

In this set of experiments, the Resin, the Polyamide Polymer, and Co in the form of cobalt neodecanoate salt incorporated in a PET compatible organic liquid carrier, were combined after drying the Polyamide Polymer (except for Comparative Example 9 where the Polyamide Polymer was used as-received without further drying) at the feed throat of a Husky injection molding machine to make 37 gram preforms, and blown into 16 oz heatset bottles by stretch blow molding.

The amount of Polyamide Polymer contained in the final formulated polyester polymer composition as a blend was measured using the following NMR technique.

Weigh 0.1 to 0.125 gm of polyester/polyamide blend sample into a 4 dram screw top vial and add a 12 mm disposable Teflon coated stir bar.

Add 2 ml of a solvent mixture of trifluoroacetic acid-d with 0.1% tetramethylsilane (TMS) and deturium oxide in a 95/5 volume ratio. Cap the vial, heat at 60C, and stir in a Pearce ReactiTherm Heating/Stirring alum. block to dissolve.

Fill a 5 mm NMR tube to the correct height with the solution and cap the tube.

Record the proton NMR signal using an average of 64 signal collections.

Collect the NMR signal using a 600 MHz (or similar instrument) NMR instrument and using standard quantitative proton NMR experimental conditions.

Analyze the NMR spectrum by measuring the correct areas and calculating the weight % MXD6 polyamide. The calculations proceed as follows:

For blends of MXD6 polyamides with Resins containing residues of cyclohexane dimethanol (CHDM Modified Resin), measure areas between the following chemical shift points referenced to TMS, and calculate using the formula.
Area A=8.75 ppm to 7.75 ppm
Area B=7.60 ppm to 7.20 ppm
Area C=5.20 ppm to a valley between 4.65 and 4.55 ppm
Area D=4.18 ppm to a valley between 4.37 and 4.32 ppm
Area E=A valley between 4.37 ppm and 4.32 ppm to a valley between 4.65 and 4.55 ppm
   Weight CHDM Modified Resin=((Area A/4)*148.11)+((Area D/4)*88.11)+(((Area C−Area B−Area D)/4)*44.05)+((Area E/4)*126.20)
   Weight Polyamide=(Area B/4)*246.31
   Weight % Polyamide=(100*Weight Polyamide)/(Weight Polyamide+Weight CHDM Modified Resin)

For blends of MXD6 polyamides with Resins containing residues of isophthalic acid (IPA Modified Resin), measure areas between the following chemical shift points referenced to TMS, and calculate using the formula.
Area A=8.75 ppm to 7.75 ppm
Area B=7.55 ppm to 7.20 ppm
Area C=5.25 ppm to 4.50 ppm
Area D=4.15 ppm to 4.40 ppm
Area E=9.00 ppm to 8.80 ppm
Area F=7.55 ppm to 7.75 ppm
   Weight IPA Modified Resin=(((Area A−Area E−Area F)/4)*148.11)+((Area D/4)*88.11)+(((Area C−Area B−Area D)/4)*44.05)+(((Area E+Area F)/2)*148.11)
   Weight Polyamide=(Area B/4)*246.31
   Weight % Polyamide=(100*Weight Polyamide)/(Weight Polyamide+Weight IPA Modified Resin)

Cobalt levels were determined via Inductively Couple Plasma (ICP).

Compositions of the preform samples that were prepared are presented in Table 4.

TABLE 4

| | | | | | | | Total | |
|---|---|---|---|---|---|---|---|---|
| | | ppm | | ppm | ppm | Ppm | ppm Co | wt % |
| | | Mn | ppm P | Sb | Ti | Zn | in blend | Polyamide |
| | | in | in | in | in | in | (by ICP | B (by |
| Example | Resin | PET | PET | PET | PET | PET | analysis) | NMR) |
| Comparative 9 | 7 | | ˜25 | ˜220 | | 0 | 99 | 0.8 |
| Comparative 10 | 7 | | ˜25 | ˜220 | | 0 | 99 | 1.1 |
| 11 | 5 | 0 | ˜70 | ˜220 | 0 | 60-65 | 74 | 0.7 |
| Comparative 12 | 7 | | ˜25 | ˜220 | | 0 | 153 | 1.5 |
| 13 | 5 | 0 | ˜70 | ˜220 | 0 | 60-65 | 118 | 1.3 |
| Comparative 14 | 7 | | ˜25 | ˜220 | | 0 | 242 | 1.4 |
| 15 | 5 | 0 | ˜70 | ˜220 | 0 | 60-65 | 222 | 0.9 |
| Comparative 16 | 6 | ˜55 | ˜98 | ˜235 | ˜20 | 0 | 126 | 1.7 |

Bottles were mounted using the procedure described above and the interiors were purged with oxygen free gas 6 to 7 days after blowing. Oxygen transmission rates for these samples are presented in Table 5. The OTR is in units of cc STP/day, the # designates the bottle number analyzed within the test sample.

TABLE 5

| | Ex | | | | | | | | | | | | | | | |
|---|---|---|---|---|---|---|---|---|---|---|---|---|---|---|---|---|
| Days | Comp. 9. | | Comp. 10 | | Ex. 11, (Sb, | | Comp. 12, | | Ex. 13, (Sb, | | Comp. 14 | | Ex. 15, (Sb, | | | |
| since | (Sb) | | (Sb) | | Zn) | | (Sb) | | Zn) | | (Sb) | | Zn) | | Comp. 16 (Ti, Mn, Sb) | |
| blowing | OTR | # | OTR | # | OTR | # | OTR | # | OTR | # | OTR | # | OTR | # | OTR | # |
| 8 | | | | | 0.0434 | 1 | | | | | | | | | 0.0396 | 3 |
| 8 | | | | | 0.0385 | 3 | | | | | | | | | 0.0370 | 2 |
| 9 | 0.0262 | 2 | 0.0290 | 1 | | | 0.0281 | 2 | 0.0357 | 2 | 0.0317 | 1 | 0.0405 | 1 | | |
| 9 | 0.0281 | 1 | 0.0241 | 3 | | | 0.0312 | 3 | 0.0373 | 1 | 0.0312 | 2 | 0.0386 | 2 | | |
| 10 | | | | | 0.0366 | 1 | | | | | | | | | 0.0339 | 3 |
| 10 | | | | | 0.0330 | 3 | | | | | | | | | 0.0320 | 2 |
| 11 | 0.0204 | 2 | 0.0233 | 1 | | | 0.0239 | 2 | 0.0291 | 2 | 0.0289 | 1 | 0.0365 | 1 | | |
| 11 | 0.0227 | 1 | 0.0191 | 3 | | | 0.0267 | 3 | 0.0322 | 1 | 0.0285 | 2 | 0.0334 | 2 | | |
| 12 | | | | | 0.0336 | 2 | | | | | | | | | 0.0325 | 1 |
| 13 | | | 0.0181 | 2 | | | 0.0269 | 1 | 0.0204 | 3 | 0.0296 | 3 | 0.0363 | 3 | | |
| 15 | | | | | 0.0323 | 1 | | | | | | | | | | |
| 16 | 0.0151 | 2 | 0.0157 | 3 | | | 0.0270 | 3 | 0.0273 | 1 | | | | | | |
| 18 | | | | | 0.0313 | 3 | | | | | | | | | 0.0290 | 2 |
| 19 | 0.0185 | 1 | 0.0161 | 2 | | | 0.0208 | 2 | 0.0142 | 2 | 0.0266 | 2 | 0.0328 | 1 | | |
| 19 | | | | | | | | | 0.0059 | 3 | | | | | | |
| 20 | | | | | 0.0310 | 2 | | | | | | | | | 0.0313 | 1 |
| 20 | | | | | 0.0335 | 1 | | | | | | | | | | |
| 21 | 0.0134 | 2 | 0.0117 | 2 | | | 0.0272 | 3 | 0.0213 | 1 | 0.0298 | 3 | 0.0345 | 3 | | |
| 22 | | | | | 0.0303 | 3 | | | | | | | | | 0.0292 | 2 |
| 22 | | | | | | | | | | | | | | | 0.0310 | 3 |
| 23 | 0.0159 | 3 | 0.0140 | 3 | | | 0.0247 | 1 | 0.0028 | 3 | 0.0275 | 2 | 0.0323 | 1 | | |
| 23 | 0.0166 | 1 | 0.0158 | 1 | | | | | 0.0089 | 2 | | | | | | |
| 23 | | | | | | | | | 0.0169 | 1 | | | | | | |
| 24 | | | | | 0.0258 | 2 | | | | | | | | | 0.0277 | 1 |
| 25 | 0.0120 | 2 | 0.0097 | 2 | | | 0.0229 | 3 | 0.0020 | 3 | 0.0239 | 1 | 0.0253 | 2 | | |
| 25 | | | | | | | | | | | 0.0255 | 3 | | | | |
| 27 | | | | | 0.0299 | 3 | | | | | | | | | 0.0286 | 2 |
| 28 | 0.0138 | 3 | 0.0137 | 1 | | | 0.0246 | 1 | 0.0110 | 1 | 0.0285 | 1 | 0.0318 | 3 | | |
| 28 | | | | | | | | | 0.0017 | 3 | | | | | | |
| 30 | | | | | 0.0241 | 2 | | | | | | | | | 0.0294 | 1 |
| 31 | 0.0098 | 2 | 0.0083 | 2 | | | 0.0260 | 3 | 0.0082 | 1 | 0.0285 | 3 | 0.0200 | 2 | | |
| 33 | | | | | 0.0275 | 3 | | | | | | | | | 0.0268 | 2 |
| 34 | 0.0117 | 3 | 0.0126 | 1 | | | 0.0263 | 1 | 0.0060 | 1 | 0.0281 | 1 | 0.0318 | 3 | | |
| 34 | | | | | | | | | 0.0014 | 3 | 0.0307 | 3 | | | | |
| 36 | | | | | 0.0242 | 2 | | | | | | | | | | |
| 36 | | | | | 0.0272 | 3 | | | | | | | | | 0.0307 | 1 |
| 37 | 0.0094 | 2 | 0.0076 | 2 | | | 0.0273 | 3 | | | | | 0.0172 | 2 | | |
| 37 | | | | | | | 0.0260 | 1 | | | | | | | | |
| 45 | | | | | 0.0202 | 3 | | | | | | | | | 0.0243 | 2 |
| 46 | 0.0120 | 3 | 0.0083 | 2 | | | 0.0247 | 3 | 0.0010 | 3 | 0.0289 | 1 | 0.0298 | 3 | | |
| 49 | | | | | 0.0094 | 2 | | | | | | | | | 0.0274 | 1 |
| 50 | 0.0090 | 2 | 0.0127 | 1 | | | 0.0252 | 1 | 0.0020 | 1 | 0.0278 | 3 | 0.0139 | 2 | | |
| 56 | | | | | 0.0103 | 3 | | | | | | | | | 0.0187 | 2 |
| 57 | 0.0117 | 3 | 0.0084 | 2 | | | 0.0252 | 3 | 0.0006 | 3 | 0.0295 | 1 | 0.0281 | 3 | | |
| 61 | | | | | 0.0024 | 2 | | | | | | | | | 0.0203 | 1 |
| 61 | | | | | | | | | | | | | | | 0.0177 | 2 |
| 62 | | | 0.0113 | 1 | | | 0.0227 | 3 | 0.0012 | 1 | 0.0291 | 3 | 0.0267 | 3 | | |
| 62 | | | | | | | | | | | | | 0.0124 | 2 | | |
| 66 | | | | | 0.0058 | 3 | | | | | | | | | | |
| 67 | 0.0093 | 2 | 0.0087 | 2 | | | 0.0268 | 3 | −0.0003 | 3 | 0.0304 | 1 | | | | |
| 67 | 0.0127 | 3 | 0.0128 | 1 | | | | | | | | | | | | |
| 71 | | | | | 0.0032 | 3 | | | | | | | | | 0.0179 | 2 |
| 71 | | | | | 0.0010 | 2 | | | | | | | | | | |
| 72 | | | | | | | 0.0251 | 1 | 0.0006 | 1 | 0.0308 | 3 | 0.0293 | 3 | | |
| 72 | | | | | | | | | | | | | 0.0122 | 2 | | |
| 77 | | | | | 0.0019 | 3 | | | | | | | | | 0.0144 | 1 |
| 78 | | | 0.0122 | 1 | | | 0.0247 | 1 | 0.0008 | 1 | 0.0299 | 1 | 0.0135 | 2 | | |
| 85 | | | | | 0.0015 | 3 | | | | | | | | | 0.0148 | 2 |
| 85 | | | | | | | | | | | | | | | 0.0136 | 1 |
| 86 | 0.0076 | 2 | 0.0133 | 1 | | | 0.0251 | 1 | 0.0005 | 3 | 0.0302 | 1 | 0.0134 | 2 | | |
| 101 | | | | | 0.0009 | 2 | | | | | | | | | 0.0140 | 2 |
| 102 | 0.0087 | 2 | 0.0143 | 1 | | | 0.0251 | 1 | 0.0006 | 3 | 0.0304 | 1 | 0.0136 | 2 | | |
| 119 | | | | | 0.0010 | 2 | | | | | | | | | 0.0041 | 1 |
| 120 | 0.0131 | 3 | 0.0107 | 2 | | | 0.0247 | 3 | 0.0015 | 1 | 0.0304 | 3 | 0.0120 | 2 | | |
| 139 | | | | | 0.0033 | 3 | | | | | | | | | 0.0122 | 2 |
| 140 | 0.0105 | 2 | 0.0161 | 1 | | | 0.0242 | 1 | 0.0008 | 3 | 0.0247 | 1 | 0.0266 | 3 | | |
| 155 | | | | | 0.0028 | 2 | | | | | | | | | 0.0092 | 2 |
| 156 | 0.0090 | 2 | 0.0120 | 2 | | | 0.0249 | 3 | 0.0011 | 3 | 0.0295 | 3 | 0.0285 | 3 | | |
| 169 | | | | | 0.0032 | 2 | | | | | | | | | | |
| 170 | | | | | | | | | 0.0046 | 1 | | | | | | |
| 173 | | | | | 0.0049 | 3 | | | | | | | | | 0.0026 | 1 |
| 174 | | | | | | | | | 0.0015 | 3 | | | | | | |
| 176 | | | | | 0.0040 | 2 | | | | | | | | | 0.0057 | 2 |
| 177 | | | | | | | | | 0.0057 | 1 | | | | | | |
| 178 | 0.0140 | 3 | 0.0141 | 1 | | | | | 0.0020 | 3 | | | 0.0114 | 2 | | |
| 178 | | | | | | | | | | | | | 0.0265 | 3 | | |
| 181 | | | | | | | 0.0244 | 1 | | | 0.0275 | 1 | | | | |
| 187 | | | | | 0.0056 | 3 | | | | | | | | | | |
| 188 | | | | | | | | | 0.0018 | 3 | | | | | | |
| 212 | | | | | 0.0063 | 2 | | | | | | | | | 0.0035 | 1 |
| 213 | | | | | | | | | 0.0079 | 1 | | | | | | |
| 225 | | | | | 0.0080 | 3 | | | | | | | | | 0.0083 | 2 |
| 226 | 0.0102 | 2 | 0.0129 | 2 | | | 00245 | 3 | 0.0031 | 3 | 0.0288 | 3 | 0.0144 | 2 | | |
| 232 | | | | | 0.0062 | 2 | | | | | | | | | 0.0032 | 1 |
| 233 | | | | | | | | | 0.0068 | 1 | | | | | | |
| 243 | | | | | 0.0074 | 2 | | | | | | | | | 0.0034 | 1 |
| 244 | | | | | | | | | 0.0034 | 3 | | | | | | |
| 249 | | | | | 0.0085 | 3 | | | | | | | | | 0.0089 | 2 |
| 250 | | | 0.0111 | 1 | | | | | 0.0080 | 1 | | | | | | |
| 256 | | | | | | | | | | | | | 0.0152 | 2 | | |
| 256 | | | | | | | | | | | | | 0.0286 | 3 | | |
| 262 | | | | | 0.0085 | 2 | | | | | | | | | 0.0012 | 1 |
| 263 | 0.0162 | 3 | 0.0149 | 2 | | | | | 0.0040 | 3 | | | | | | |
| 288 | | | | | 0.0110 | 3 | | | | | | | | | 0.0141 | 2 |
| 289 | | | 0.0197 | 1 | | | | | 0.0106 | 1 | | | | | | |
| 293 | | | | | | | | | | | | | | | 0.0059 | 1 |
| 294 | | | | | | | | | 0.0055 | 3 | | | | | | |
| 300 | | | 0.0186 | 2 | | | | | | | | | 0.0181 | 2 | | |
| 300 | | | | | | | | | | | | | 0.0304 | 3 | | |
| 313 | | | | | 0.0101 | 2 | | | | | | | | | 0.0147 | 2 |
| 314 | | | 0.0196 | 1 | | | | | 0.0112 | 1 | | | | | | |
| 322 | | | | | | | | | | | | | | | 0.0067 | 1 |
| 323 | | | | | | | | | 0.0069 | 3 | | | | | | |
| 342 | | | | | 0.0132 | 3 | | | | | | | | | 0.0167 | 2 |
| 343 | | | 0.0163 | 2 | | | | | 0.0075 | 3 | | | | | | |
| 350 | | | | | | | | | 0.0144 | 1 | | | | | | |
| 369 | | | | | 0.0132 | 2 | | | | | | | | | 0.0097 | 1 |
| 370 | | | 0.0221 | 1 | | | | | 0.0074 | 3 | | | | | | |
| 393 | | | | | 0.0122 | 3 | | | | | | | | | 0.0184 | 2 |
| 394 | | | | | | | | | 0.0112 | 1 | | | | | | |
| 397 | | | 0.0202 | 2 | | | | | | | | | | | | |
| 424 | | | | | 0.0138 | 2 | | | | | | | | | 0.0152 | 1 |
| 425 | | | 0.0230 | 1 | | | | | 0.0067 | 3 | | | | | | |

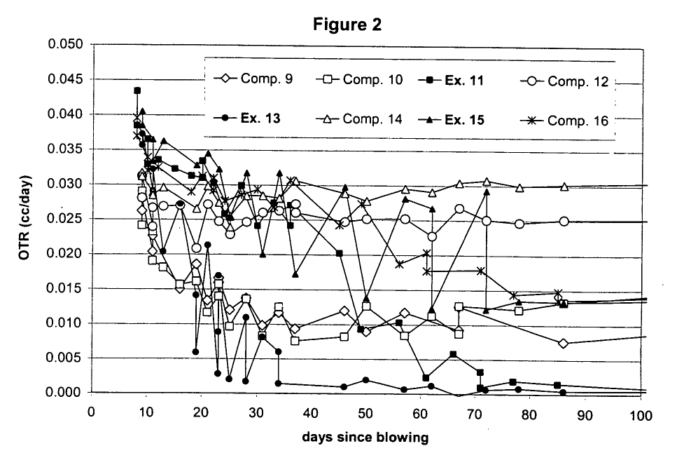

FIG. 2 is a graph of the data set forth in Table 5 within a limited time frame from 0 to about 100 days to illustrate the relative differences in the oxygen transmission rate into bottles over time made from the Resins and compositions described in Table 4. The graph illustrates the differences between in OTR between compositions of the invention compared to compositions that do not contain zinc.

A comparison of Example 11 with Comparative Examples 9 and 10, a comparison of Example 13 with Comparative Examples 12 and 16, and a comparison of Example 15 with Comparative Example 14 (grouped by comparable levels of cobalt) indicates that the bottles made with formulated polyester polymer compositions containing zinc exhibited superior performance (lower OTR over long periods of time) relative to similar compositions made without zinc.

### Experiment 3

In this set of experiments, the target amount of cobalt added at the preform molding step was kept constant at 100 ppm (for all but one). In a first series, the amount of Polyamide Polymer A was kept constant at a target of 1.5 wt. % while varying the types of Resins and metals, and in a second series, the amount of Polyamide Polymer A was increased and kept constant at a target of 2.5 wt. % while varying the types of Resins and metals. In each case, PET and polyamide were dried separately. The dried pellets and cobalt (in a liquid carrier) were mixed prior to loading the sample into the hopper of the Husky injection molding machine.

The resin blend of Comparative Example No. 22 was prepared using a PET produced and marketed by Kosa (now Invista) as Kosa 2201 resin which contained 96 ppm Co, 67 ppm Zn, 258 ppm Sb and 73 ppm P. The cobalt present in this resin was presumably added during melt phase polymerization, and no additional cobalt was added to the polyester polymer to the injection molding machine for making the preform.

Table 6 sets forth the compositions of the fully formulated polyester polymers.

TABLE 6

| | | | | | | | | Polyamide |
|---|---|---|---|---|---|---|---|---|
| | | | | | | | | Polymer A |
| | | Sb | P | Zn | Co | Ti | Mn | wt % |
| Example # | Resin # | (ppm) | (ppm) | (ppm) | (ppm) | (ppm) | (ppm) | (NMR) |
| 17 | Resin 5 | 226 | 75 | 58 | 108 | 0 | 1 | 1.3 |
| 18 | Resin 8 | 217 | 58 | 59 | 110 | 0 | 1 | 1.5 |
| Comp. 19 | Resin 6 | 241 | 92 | 0 | 108 | 19 | 56 | 1.5 |
| Comp. 20 | Resin 7 | 244 | 29 | 0 | 138 | 0 | 1 | 1.3 |
| Comp. | Resin 9 | 239 | 27 | 0 | 106 | 0 | 1 | 1.4 |
| 21 | | | | | | | | |
| Comp. 22 | Kosa 2201 | 258 | 73 | 67 | 96 | 0 | 2 | 1.4 |
| 23 | Resin 5 | 228 | 77 | 60 | 106 | 0 | 1 | 2.3 |
| Comp. | Resin 7 | 244 | 31 | 0 | 134 | 0 | 1 | 2.1 |
| 24 | | | | | | | | |

48 gram preforms with 43 mm finishes were molded on a Husky LX160PET P60/50 E42 machine using a 4 cavity preform tool. Blends were prepared by mixing dried, solid pellets of polyester resins and Polyamide polymer A with cobalt salt dispersed in a liquid carrier (mineral oil) and prior to addition to the molding machine hopper. Standard preform molding conditions were found to give acceptable preforms. These included barrel and manifold temperature settings of 280° C. and a total cycle time of 29 (plus or minus 1) sec.

These preforms were blow molded into 1-liter, heatset bottles on a Sidel SBO2/3 machine equipped to produce heat set bottles using heated blow molds and balayage internal bottle cooling. Percent oven power was adjusted to yield bottles that were judged to have optimal appearance (clarity) while maintaining relatively constant section weights for all examples.

Bottles were mounted for OTR testing and purged one day after blowing. OTR's were tested as in the preceding experiments. The results of the OTR tests are set forth below in Table 7.

TABLE 7

| Days | | | | | | | | | | | | | | | | |
|---|---|---|---|---|---|---|---|---|---|---|---|---|---|---|---|---|
| since | Comp. 19 | | Comp. 22 | | Comp. 20 | | Comp. 24 | | Comp. 21 | | Example 18 | | Example 17 | | Example 23 | |
| blowing | OTR | # | OTR | # | OTR | # | OTR | # | OTR | # | OTR | # | OTR | # | OTR | # |
| 5 | | | | | | | | | 0.0555 | 3 | 0.0645 | 3 | 0.0555 | 2 | 0.0472 | 1 |
| 5 | | | | | | | | | 0.0512 | 1 | 0.0518 | 1 | | | | |
| 6 | 0.0644 | 2 | 0.0647 | 3 | 0.0559 | 2 | 0.0187 | 3 | | | | | | | | |
| 6 | 0.0596 | 3 | 0.0595 | 2 | 0.0478 | 3 | 0.0126 | 2 | | | | | | | | |
| 9 | | | | | | | | | 0.0486 | 2 | 0.0473 | 2 | 0.0402 | 3 | 0.0022 | 2 |
| 9 | | | | | | | | | 0.0517 | 3 | 0.0508 | 1 | 0.0460 | 1 | 0.0082 | 3 |
| 10 | 0.0546 | 1 | 0.0482 | 1 | 0.0393 | 1 | 0.0048 | 1 | | | | | | | | |
| 10 | 0.0586 | 2 | 0.0584 | 2 | | | | | | | | | | | | |
| 13 | | | | | | | | | 0.0525 | 1 | 0.0299 | 1 | 0.0198 | 1 | 0.0018 | 3 |
| 13 | | | | | | | | | | | 0.0347 | 3 | 0.0352 | 2 | 0.0016 | 1 |
| 14 | 0.0508 | 2 | 0.0555 | 3 | 0.0476 | 2 | 0.0012 | 1 | | | | | | | | |
| 14 | 0.0569 | 3 | | | 0.0423 | 1 | 0.0026 | 2 | | | | | | | | |
| 14 | | | | | | | 0.0025 | 3 | | | | | | | | |
| 17 | | | | | | | | | | | | | | | 0.0007 | 2 |
| 17 | | | | | | | | | | | | | | | 0.0006 | 1 |
| 18 | | | | | | | | | | | | | | | | |
| 18 | | | | | | | 0.0020 | 2 | | | | | | | | |
| 18 | | | | | | | 0.0015 | 3 | | | | | | | | |
| 18 | | | | | | | 0.0008 | 1 | | | | | | | | |
| 19 | | | | | | | | | 0.0430 | 3 | 0.0102 | 1 | 0.0037 | 1 | 0.0014 | 3 |
| 19 | | | | | | | | | 0.0526 | 1 | 0.0083 | 3 | 0.0076 | 2 | | |
| 20 | 0.0594 | 3 | 0.0528 | 2 | 0.0351 | 2 | | | | | | | | | | |
| 20 | | | 0.0533 | 1 | 0.0269 | 3 | | | | | | | | | | |
| 20 | | | | | 0.0353 | 1 | | | | | | | | | | |
| 22 | | | | | | | | | 0.0386 | 2 | 0.0044 | 2 | 0.0014 | 3 | 0.0010 | 2 |
| 23 | 0.0501 | 2 | 0.0492 | 3 | 0.0316 | 2 | 0.0019 | 2 | | | | | | | | |
| 25 | | | | | | | | | 0.0431 | 1 | 0.0054 | 3 | 0.0025 | 1 | | |
| 26 | 0.0506 | 1 | 0.0502 | 2 | 0.0226 | 3 | | | | | | | | | | |
| 26 | | | | | | | | | | | | | | | | |
| 33 | | | | | | | | | 0.0371 | 3 | 0.0058 | 1 | 0.0021 | 2 | 0.0006 | 1 |
| 34 | 0.0567 | 3 | 0.0510 | 1 | 0.0288 | 1 | | | | | | | | | | |
| 36 | | | | | | | | | | | | | 0.0008 | 3 | | |
| 37 | | | | | | | 0.0005 | 3 | | | | | | | | |
| 40 | | | | | | | | | 0.0313 | 2 | 0.0009 | 2 | 0.0007 | 1 | 0.0009 | 3 |
| 41 | 0.0546 | 2 | 0.0543 | 3 | 0.0253 | 2 | | | | | | | | | | |
| 47 | | | | | | | | | 0.0329 | 1 | | | | | | |
| 48 | | | | | 0.0251 | 3 | | | | | | | | | | |
| 50 | | | | | | | | | | | 0.0049 | 3 | 0.0006 | 2 | 0.0002 | 2 |
| 51 | 0.0518 | 1 | 0.0550 | 2 | | | 0.0007 | 1 | | | | | | | | |
| 61 | | | | | | | | | 0.0154 | 3 | | | | | | |
| 62 | 0.0440 | 3 | 0.0440 | 1 | 0.0207 | 1 | | | | | | | | | | |
| 66 | | | | | | | | | 0.0221 | 2 | 0.0015 | 1 | 0.0044 | 3 | 0.0007 | 1 |
| 67 | 0.0506 | 2 | 0.0530 | 3 | | | 0.0010 | 2 | | | | | | | | |
| 70 | 0.0459 | 1 | 0.0494 | 2 | 0.0165 | 2 | | | | | | | | | | |
| 72 | | | | | 0.0222 | 3 | | | 0.0254 | 1 | | | 0.0005 | 1 | | |
| 88 | | | | | | | | | 0.0130 | 3 | 0.0012 | 1 | 0.0007 | 2 | | |
| 89 | 0.0433 | 3 | 0.0442 | 1 | 0.0280 | 1 | | | | | | | | | | |
| 97 | | | | | | | | | 0.0254 | 2 | | | | | 0.0008 | 3 |
| 98 | | | | | 0.0261 | 2 | 0.0006 | 3 | | | | | | | | |
| 103 | | | | | | | | | | | 0.0009 | 2 | 0.0006 | 1 | | |
| 104 | 0.0517 | 2 | 0.0538 | 3 | | | | | | | | | | | | |
| 106 | | | | | | | | | 0.0256 | 1 | | | | | | |
| 107 | | | | | 0.0337 | 3 | | | | | | | | | | |
| 114 | | | | | | | | | | | 0.0012 | 3 | 0.0005 | 3 | | |
| 122 | | | | | | | | | 0.0143 | 3 | | | | | | |
| 123 | 0.0541 | 1 | 0.0555 | 2 | 0.0399 | 3 | | | | | | | | | | |
| 162 | | | | | | | | | | | 0.0007 | 1 | 0.0001 | 2 | | |
| 163 | 0.0463 | 3 | 0.0497 | 1 | | | | | | | | | | | | |
| 164 | | | | | | | | | 0.0184 | 2 | | | | | | |
| 165 | | | | | 0.0254 | 1 | | | | | | | | | | |
| 180 | | | | | | | | | | | | | | | 0.0007 | 2 |
| 181 | | | | | | | 0.0006 | 1 | | | | | | | | |
| 189 | | | | | | | | | 0.0206 | 1 | 0.0018 | 2 | 0.0014 | 1 | | |
| 190 | 0.0444 | 2 | 0.0482 | 3 | 0.0261 | 2 | | | | | | | | | | |
| 218 | | | | | | | | | 0.0085 | 3 | 0.0016 | 3 | | | 0.0004 | 1 |
| 219 | 0.0509 | 1 | 0.0535 | 2 | 0.0356 | 3 | | | | | | | | | | |
| 223 | | | | | | | 0.0007 | 3 | | | | | 0.0011 | 3 | | |

*Bottle number
**Units in cc/day

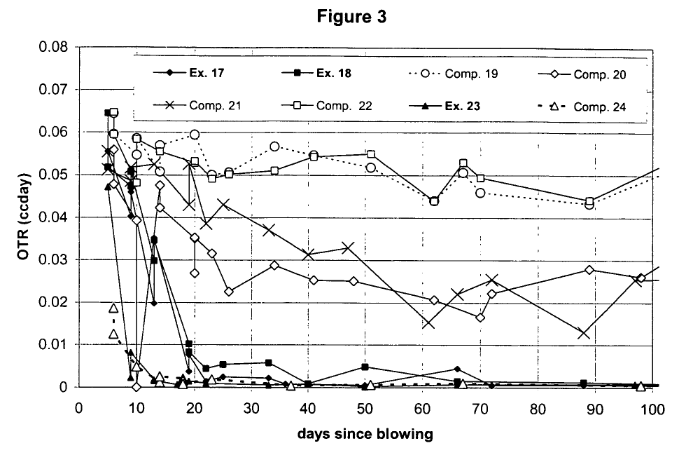

FIG. 3 is a graph of the data in Table 7 illustrating the oxygen transmission rates into bottles over time made from compositions set forth in Table 6. The graph illustrates the differences in OTR performance of bottles made from the resin compositions of the invention compared to resin compositions that do not contain zinc, as well as illustrating the effects on OTR by varying the levels of Polyamide.

The results indicate that bottles containing Zn and a target 1.5 wt. % of the Polyamide Polymer A (actual levels 1.3 to 1.5%) had a much shorter induction period, and much lower OTR, than other bottles made with compositions that did not contain Zn at the comparable levels of Polyamide Polymer A. Compare Examples 17 and 18 containing Zn with Comparative Examples 19, 20, and 21 which contain approximately the same amount of Polyamide Polymer A but no zinc. The superior performance of the compositions of the invention was evident even through the Comparative Examples contained metals in common, such as Sb and Co.

The OTR and induction period performances of Examples 17 and 18 were also superior to the composition of Comparative Example 22 which did contain a level of zinc and cobalt but was made without using virgin cobalt.

At higher levels of Polyamide Polymer A, the oxygen scavenging performance of the bottle made from the composition containing Zn/Sb/Co Example 23, and the bottle made from the composition containing only Sb/Co, Comparative 24, was similar if not identical in terms of short induction periods and low oxygen transmission rates. However, the data indicates that in order to make a bottle having short induction periods and low overall oxygen transmission rates without zinc as in Comparative Example 24, the formulation must contain larger concentrations of Polyamide Polymer A. Larger amounts of Polyamide Polymer A lead to higher haze values as indicated in Table 8 below. Further, as the data in Table 7 indicates, when the amount of Polyamide Polymer A polymer is lowered as in Comparative Example 20 relative to the same Resin as used in Comparative Example 24 in order to produce a bottle with lower haze, the oxygen transmission rate is high and the induction period is too long. Thus, by the addition of Zn metal, one has wide formulation latitude to produce a bottle which has excellent oxygen scavenging capabilities in the sense of short induction periods, low OTR, and long capacity, and if desired, this superior oxygen scavenging performance can be obtained at very low levels of oxygen scavenging polymers thereby lowering the level of haze appearing the in bottle. However, if the haze is not evident at higher levels of the oxygen scavenging polymer, or it the haze is high but acceptable in the particular application, such as in pigmented packages or tinted bottles, one also has the flexibility of using higher amounts of the oxygen scavenging polymer. Even where haze is not an important consideration, cost savings are realized by using less oxygen scavenging polymer to obtain comparable or acceptable oxygen scavenging performance.

Haze measurements were performed on sections cut from 3 of the 6 panels (located on the sidewall of the heatset bottle) for each bottle tested. Two bottles were tested per example and the average results are reported in Table 8 as are the average thickness for the respective haze specimens. Haze was measured using a BYK-Gardner HazeGuard Plus according to ASTM D1003, Method A. Bottle sections are placed concave-in against the haze port and held taut to flatten the sample as much as possible.

TABLE 8

| | | Thickness |
|---|---|---|
| Example # | Haze % | (mm) |
| 17 | 5.43 | 0.321 |
| Comp. 20 | 5.91 | 0.320 |
| 23 | 6.9 | 0.323 |
| Comp. 24 | 8.14 | 0.321 |

The amount of carbonyl ester-amide exchanged for Examples 17 and 23 was measured using the carbon -13 method for blends of PET with MXD6 described above. The measured amount of carbonyl ester-amide exchanged for Example 17 was 0 mole % (within the error of the technique) and for Example 23 was 0.1 mole %.

### Experiment 4

This series of experiments further demonstrates that cobalt, when used as a polymerization catalyst in a melt, is no longer effective to scavenge oxygen to any significant extent, leading to the conclusion that virgin cobalt is needed to provide optimal oxygen scavenging performance.

Virgin cobalt in the form of cobalt neodecanoate in a suitable liquid carrier was added to Resins 10 and 11 during the injection molding process. The liquid cobalt was dosed at the correct let down by using a positive displacement pump. The liquid was introduced above the machine feed throat into blending chamber, where the PET/polyamide blend and the liquid cobalt are intimately blended using an in-line mixer.

Other than cobalt added during melt phase polymerization during the manufacture of the resin, no further cobalt was added to Resins 12, 13, or 14.

The final metal content of formulated samples made with Resins 10-14 are summarized in Table 9. Each of the compositions of the examples in Table 9 also contained at target of 1.5 wt % Polyamide Polymer A, and it is believed that the actual level achieved was around 1.49 (plus or minus 0.3) wt % Polyamide polymer A.

TABLE 9

| | Cobalt added during | | | | | |
|---|---|---|---|---|---|---|
| | polymerization or via | | | | | |
| | concentrate at injection | | Co | Zn | Sb | P |
| Example # | molding machine | Resin # | (ppm) | (ppm) | (ppm) | (ppm) |
| 25 | Injection molding | 10 | 159 | 64 | 238 | 65 |
| 26 | Injection molding | 11 | 121 | 60 | 240 | 62 |
| Comparative 27 | Polymerization | 12 | 62 | 60 | 244 | 85 |
| Comparative 28 | Polymerization | 13 | 88 | 62 | 256 | 90 |
| Comparative 29 | Polymerization | 14 | 68 | 61 | 263 | 90 |

Preforms were manufactured on a 2 cavity Husky LX 160 PET machine. A similar injection set-up was used for all the runs. Preforms were converted to 16 oz stock hot-fill containers using a lab SBO-1 Sidel machine.

Bottles were mounted for OTR testing and purged twelve days after blowing. OTR's were tested as in the preceding experiments. The results of the OTR tests are set forth below in Table 10.

TABLE 10

| Days | | | | | | | | | | |
|---|---|---|---|---|---|---|---|---|---|---|
| since | Example 25 | | Example 26 | | Comparative 27 | | Comparative 28 | | Comparative 29 | |
| blowing | (cc/day) | Bottle # | (cc/day) | Bottle # | (cc/day) | Bottle # | (cc/day) | Bottle # | (cc/day) | Bottle # |
| 16 | | | 0.0119 | 2 | | | 0.0305 | 2 | 0.0294 | 2 |
| 19 | 0.0107 | 3 | 0.0111 | 3 | 0.0353 | 2 | 0.0342 | 3 | 0.0287 | 1 |
| 19 | | | | | 0.0349 | 3 | | | | |
| 23 | 0.0073 | 2 | 0.0102 | 1 | 0.0288 | 2 | 0.0296 | 1 | 0.0291 | 3 |
| 23 | | | | | | | | | | |
| 26 | | | 0.0057 | 2 | 0.0274 | 2 | 0.0279 | 3 | 0.0268 | 2 |
| 26 | | | | | 0.0284 | 3 | | | | |
| 32 | 0.0089 | 3 | 0.0055 | 3 | 0.0328 | 3 | 0.0322 | 2 | 0.0334 | 1 |
| 32 | | | | | | | | | | |
| 39 | 0.0048 | 2 | 0.0049 | 1 | 0.0316 | 2 | 0.0322 | 1 | 0.0319 | 3 |
| 39 | | | | | | | | | | |
| 45 | | | 0.0035 | 2 | 0.0360 | 3 | 0.0323 | 3 | 0.0318 | 2 |
| 45 | 0.0052 | 3 | | | | | | | | |
| 47 | 0.0035 | 2 | 0.0032 | 3 | 0.0281 | 2 | 0.0286 | 2 | 0.0300 | 1 |
| 61 | 0.0049 | 3 | 0.0070 | 1 | 0.0272 | 3 | 0.0274 | 1 | 0.0272 | 3 |
| 61 | | | 0.0045 | 2 | | | | | | |
| 73 | | | | | 0.0259 | 2 | 0.0260 | 3 | | |
| 79 | | | | | | | | | 0.0278 | 2 |
| 82 | 0.0044 | 2 | 0.0039 | 3 | 0.0305 | 3 | 0.0301 | 2 | 0.0307 | 1 |
| 93 | | | | | | | | | | |
| 98 | | | | | 0.0301 | 2 | 0.0315 | 1 | 0.0316 | 3 |
| 138 | 0.0043 | 2 | 0.0048 | 2 | | | | | | |
| 156 | 0.0029 | 2 | 0.0055 | 1 | | | | | | |
| 156 | 0.0041 | 3 | 0.0031 | 3 | | | | | | |

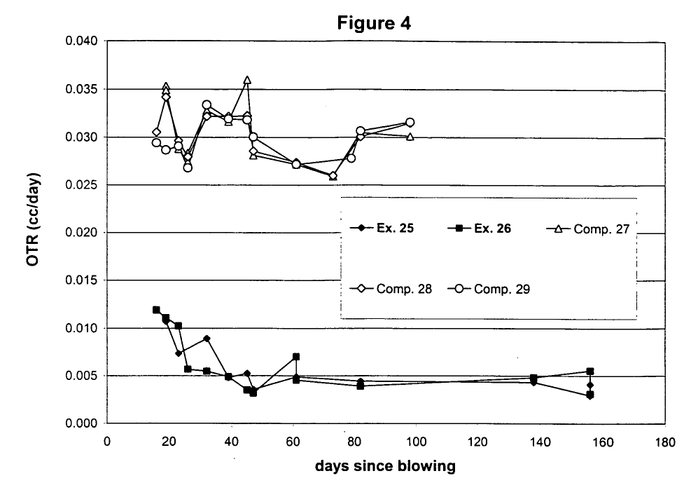

FIG. 4 is a graphical illustration of the oxygen transmission rates into bottles over time made from the resin compositions of the invention containing virgin cobalt relative to similar compositions which contain cobalt added only in the melt phase polymerization.

The data in Table 10 and as illustrated in FIG. 4 indicates that when cobalt was added to a melt phase for polycondensing the polyester polymer as in Comparative Examples 27, 28, and 29, the oxygen scavenging activity of the resulting bottle was virtually non-existent. This result could not be foreseen after only about 20-40 days since in many instances, there was a noticeable reduction in the OTR during that short period of time. However, it is evident that over a period of 100-180 days, the OTR never dropped below 0.02 cc STP/day, and therefore also did not possess an induction period. By contrast, when a measure of cobalt was added as virgin cobalt as in Examples 25 and 26, the oxygen scavenging activity was excellent as shown by the short induction periods and low OTR over time. See also FIG. 2 where the OTR of Comparative Examples 9 and 10 is initially favorable but ultimately fails to achieve acceptable OTR levels. The data presented above underscores why measuring the relative improvement by percentage in oxygen transmission over short time periods, is not a reliable indicator of bottle capacity or whether the OTR values will drop to a desirably low OTR level. The absolute level of oxygen scavenging should be measured and reported to conclude whether or not satisfactory levels can be obtained, whether the bottle possesses desired capacity at the low OTR levels over time, and whether the rate to achieve a particular level of oxygen scavenging is obtained as a measure of its induction period.

We claim:

1. A molten formulated polyester polymer composition comprising zinc, cobalt, and a blend of a polyester polymer and an oxygen scavenging composition, the oxygen scavenging composition present in an amount ranging from 0.10 wt. % to 10 wt. % based on the combined weight of the polyester polymer and the oxygen scavenging composition, and
(A) said polyester polymer comprising:
(i) a polycarboxylic acid component comprising at least 85 mole % of the residues of terephthalic acid, derivates of terephthalic acid, naphthalene-2,6-dicarboxylic acid, derivatives of naphthalene-2,6-dicarboxylic acid, or mixtures thereof, and
(ii) a hydroxyl component comprising at least 50 mole % of the residues of C₂-C₄ aliphatic saturated diols,
wherein (a) and (b) are based on 100 mole percent of the polycarboxylic acid residues and 100 mole percent hydroxyl residues, respectively, in the polyester polymer; and
(B) said oxygen scavenging composition comprising a polyamide polymer, and at least a portion of the cobalt present in said molten composition is virgin cobalt.

2. The composition of claim 1, wherein the composition contains at least 10 ppm Sb.

3. The composition of claim 2, wherein the composition contains 100 to 300 ppm Sb.

4. The composition of claim 2, wherein the composition contains phosphorus atoms in a molar ratio of phosphorus to antimony and zinc atoms in the range of 0.025:1 to 5.0:1.

5. The composition of claim 1, wherein the oxygen scavenging composition comprises a polyamide polymer in an amount ranging from 1.0 to 5.0 wt %.

6. The composition of claim 5, wherein the amount of virgin Co in said composition ranges from 50 to 150 ppm and the amount of polyamide polymer ranges from 1.0 to 3.0 wt. %.

7. The composition of claim 6, wherein the amount of Zn in said composition ranges from 20 to 80 ppm.

8. The composition of claim 6, wherein the (A) polyester polymer contains at least:
(i) a carboxylic acid component comprising at least 92 mole % of the residues of terephthalic acid, or derivates of terephthalic acid, or mixtures thereof, and
(ii) a hydroxyl component comprising at least 92 mole % of the residues of ethylene glycol,
based on 100 mole percent of the polycarboxylic acid component residues and 100 mole percent hydroxyl component residues in the polyester polymer, respectively.

9. The composition of claim 8, wherein the polyester polymer contains at least:
(i) a carboxylic acid component comprising at least 96.0 mole % of the residues of terephthalic acid, or derivates of terephthalic acid, or mixtures thereof, and
(ii) a hydroxyl component comprising at least 92.0 mole % of the residues of ethylene glycol,
based on 100 mole percent of the carboxylic acid component residues and 100 mole percent hydroxyl component residues in the polyester polymer, respectively.

10. The composition of claim 1, comprising a polyamide polymer present in an amount ranging from 1.0 to 3.0 wt. %, the melt further comprising Sb, wherein Sb and said Zn are present in the composition as residual metals from Sb containing compounds and Zn containing compounds added to a melt phase process in the manufacture of the polyester polymer.

11. The composition of claim 1, wherein the source of the cobalt in the melt is a cobalt salt in a liquid carrier.

12. The composition of claim 1, wherein the oxygen scavenging compound comprises a polyamide polymer containing benzylic hydrogen atoms.

13. The composition according to claim 12, wherein said polyamide contains repeating residues of m-xylylenediamine.

14. The composition of claim 1, wherein the number average molecular weight of the polyamide is 12,000 or less.

15. The composition of claim 1, wherein the polyamide comprises poly(m-xylylene adipamide).

16. The composition of claim 1, wherein the polyester polymer contains at least:
(i) a carboxylic acid component comprising at least 92.0 mole % of the residues of terephthalic acid, or derivates of terephthalic acid, or mixtures thereof, and
(ii) a hydroxyl component comprising at least 92.0 mole % of the residues of ethylene glycol,
based on 100 mole percent of the carboxylic acid component residues and 100 mole percent hydroxyl component residues in the polyester polymer, respectively; and
the amount of virgin cobalt ranges from 50 ppm to 150 ppm, the amount of zinc ranges from 20 to 80 ppm, and the oxygen scavenging composition comprises a polyamide polymer in an amount ranging from 1.0 wt. % to 3.0 wt. %.

17. The composition of claim 1, wherein the It.V. of the melt in the melt processing zone does not increase.

18. The composition of claim 1, wherein the total amount of cobalt in the composition is provided by a portion of cobalt in the polyester polymer and a portion of cobalt from the supply of virgin cobalt.

19. The composition of claim 1, wherein the polyamide polymer has a degree of transesterification in a molar amount of 1.0 mole % or less.

20. A process for making an article, comprising:
(a) combining a polyester polymer and an oxygen scavenging composition comprising a polyamide in the presence of zinc and a cobalt in a melt processing zone to form a melt; and
(b) forming an article such as a sheet or preform from the melt.

21. The process of claim 20, wherein the amount of zinc in the melt is at least 10 ppm; the oxygen scavenging composition comprises a polyamide polymer in an amount of at least 1.0 wt. %, based on the weight of the oxygen scavenging composition and the polyester polymer, and at least a portion of the cobalt is virgin cobalt present in an amount of at least 20 ppm, based on the weight of the blend.

22. The method of claim 20, wherein the polyester polymer has an It.V. of at least 0.65.

23. The method of claim 22, wherein the blend is injection molded into a mold for making monolayer bottle preforms.

24. The method of claim 20, wherein the melt is processed in the melt processing zone at temperatures within a range of 250° C. to 300° C. within a total cycle time to the formation of the article in less than 6 minutes.

25. The method of claim 24, wherein no vacuum is applied to the melt processing zone.

26. The method of claim 25, wherein a pressure ranging from 100 psig to 900 psig is applied to the melt processing zone.

27. The method of claim 20, wherein the blend is extruded through a die to form a sheet, followed by thermoforming the sheet into the shape of a tray or bottle.

28. The method of claim 20, wherein the amount of polyamide in the blend ranges from 1.0 to 3.0 wt. %, based on the weight of the weight of the oxygen scavenging composition and the polyester polymer.

29. The method of claim 20, wherein the oxygen scavenging composition comprising a polyamide polymer, cobalt, and the polyester polymer containing zinc are fed into the melt processing zone as separate feeds.

30. The method of claim 20, wherein the cobalt is fed as a cobalt salt of an organic acid.

31. The method of claim 20, wherein the polyester composition contains at least 10 ppm Sb.

32. The method of claim 20, wherein a polyester polymer composition containing cobalt and zinc is fed to the melt processing zone, an additional amount of at least 20 ppm virgin cobalt is fed to the melt processing zone, and a polyamide polymer is fed to the melt processing zone.

33. The method of claim 32, wherein the composition contains phosphorus atoms in a molar ratio of phosphorus to antimony and zinc atoms in the range of 0.025:1 to 5.0:1.

34. The method of claim 33, wherein the amount of Co in said blend ranges from 50 to 150 ppmw, the amount of Zn in the blend ranges from 20 to 80 ppmw, and the oxygen scavenger comprises a polyamide polymer in an amount ranging from 1.0 to 5.0 wt. %, each based on the weight of the blend.

35. The method of claim 20, comprising forming a monolayer bottle preform.

36. The method of claim 35, comprising stretch blow molding said preform into a bottle.

37. The method of claim 36, wherein the polyester polymer contains at least:
(i) a carboxylic acid component comprising at least 92 mole % of the residues of terephthalic acid, or derivates of terephthalic acid, or mixtures thereof, and
(ii) a hydroxyl component comprising at least 92 mole % of the residues of ethylene glycol,
based on 100 mole percent of the polycarboxylic acid component residues and 100 mole percent hydroxyl component residues in the polyester polymer, respectively.

38. The method of claim 37, wherein the polyester polymer contains at least:
(i) a carboxylic acid component comprising at least 96.0 mole % of the residues of terephthalic acid, or derivates of terephthalic acid, or mixtures thereof, and
(ii) a hydroxyl component comprising at least 92.0 mole % of the residues of ethylene glycol,
based on 100 mole percent of the carboxylic acid component residues and 100 mole percent hydroxyl component residues in the polyester polymer, respectively.

39. The method of claim 20, wherein said oxygen scavenging composition comprises a polyamide polymer containing repeating residues of m-xylylene.

40. The method of claim 20, wherein the melt is processed in the melt processing zone at temperatures within a range of 250° C. to 300° C. at a cycle time of less than 6 minutes.

41. The method of claim 40, wherein no vacuum is applied to the melt processing zone.

42. The method of claim 41, wherein a pressure ranging from 100 psig to 900 psig is applied to the melt processing zone.

43. An isolated solid comprising a sheet, a preform or a bottle, said solid comprising zinc, cobalt, and a blend of a polyester polymer and an oxygen scavenging composition, the oxygen scavenging composition present in an amount ranging from 0.10 wt. % to 10 wt. % based on the combined weight of the polyester polymer and the oxygen scavenging composition, and
(A) said polyester polymer comprising:
(a) a polycarboxylic acid component comprising at least 85 mole % of the residues of terephthalic acid, derivates of terephthalic acid, naphthalene-2,6-dicarboxylic acid, derivatives of naphthalene-2,6-dicarboxylic acid, or mixtures thereof, and
(b) a hydroxyl component comprising at least 50 mole % of the residues of C₂-C₄ aliphatic saturated diols,
based on 100 mole percent of the polycarboxylic acid residues and 100 mole percent hydroxyl residues, respectively, in the polyester polymer; and
(B) said oxygen scavenging composition comprising a polyamide polymer.

44. The composition of claim 43, wherein the composition contains at least 10 ppmw Sb.

45. The composition of claim 44, wherein the composition contains 100 to 300 ppmw Sb.

46. The composition of claim 44, wherein the composition contains phosphorus atoms in a molar ratio of phosphorus to antimony and zinc atoms in the range of 0.025:1 to 5.0:1.

47. The composition of claim 45, wherein the oxygen scavenging composition comprises a polyamide polymer in an amount ranging from 1.0 to 5.0 wt %.

48. The composition of claim 47 wherein the amount of virgin Co in said composition ranges from 50 to 150 ppmw and the amount of polyamide polymer ranges from 1.0 to 3.0 wt. %.

49. The composition of claim 48 wherein the amount of Zn in said composition ranges from 20 to 80.

50. The composition of claim 48, wherein the (A) polyester polymer contains at least:
(i) a carboxylic acid component comprising at least 92 mole % of the residues of terephthalic acid, or derivates of terephthalic acid, or mixtures thereof, and
(ii) a hydroxyl component comprising at least 92 mole % of the residues of ethylene glycol,
based on 100 mole percent of the polycarboxylic acid component residues and 100 mole percent hydroxyl component residues in the polyester polymer, respectively.

51. The composition of claim 50, wherein the polyester polymer contains at least:
(i) a carboxylic acid component comprising at least 96.0 mole % of the residues of terephthalic acid, or derivates of terephthalic acid, or mixtures thereof, and
(ii) a hydroxyl component comprising at least 92.0 mole % of the residues of ethylene glycol,
based on 100 mole percent of the carboxylic acid component residues and 100 mole percent hydroxyl component residues in the polyester polymer, respectively.

52. The composition of claim 43, comprising a polyamide polymer present in an amount ranging from 1.0 to 3.0 wt. %, the melt further comprising Sb, wherein Sb and said Zn are present in the composition as residual metals from Sb containing compounds and Zn containing compounds added to a melt phase process in the manufacture of the polyester polymer.

53. The composition of claim 43, wherein the source of the cobalt in the melt is a cobalt salt in a liquid carrier.

54. The composition of claim 43, wherein the oxygen scavenging compound comprises a polyamide polymer containing benzylic hydrogen atoms.

55. The composition according to claim 43, wherein said polyamide contains repeating residues of m-xylylenediamine.

56. The composition of claim 43, wherein the number average molecular weight of the polyamide is 12,000 or less.

57. The composition of claim 43, wherein the polyamide comprises a partially aromatic polyamide having a number average molecular weight of 7,000 or less.

58. The composition of claim 43, wherein the polyester polymer contains at least:
(i) a carboxylic acid component comprising at least 92.0 mole % of the residues of terephthalic acid, or derivates of terephthalic acid, or mixtures thereof, and
(ii) a hydroxyl component comprising at least 92.0 mole % of the residues of ethylene glycol,
based on 100 mole percent of the carboxylic acid component residues and 100 mole percent hydroxyl component residues in the polyester polymer, respectively; and
the amount of virgin cobalt ranges from 50 ppmw to 150 ppmw, the amount of zinc ranges from 20 to 80 ppmw, and the oxygen scavenging composition comprises a polyamide polymer in an amount ranging from 1.0 wt. % to 3.0 wt. %.

59. A solid concentrate comprising a blend of a polyester polymer and an oxygen scavenging composition, the oxygen scavenging composition present in an amount ranging from greater than 10 wt. % to 50 wt. % based on the combined weight of the polyester polymer and the oxygen scavenging composition, and
(A) said polyester polymer comprising:
(a) a polycarboxylic acid component comprising at least 85 mole % of the residues of terephthalic acid, derivates of terephthalic acid, naphthalene-2,6-dicarboxylic acid, derivatives of naphthalene-2,6-dicarboxylic acid, or mixtures thereof, and
(b) a hydroxyl component comprising at least 50 mole % of the residues of C₂-C₄aliphatic saturated diols,
based on 100 mole percent of the polycarboxylic acid residues and 100 mole percent hydroxyl residues, respectively, in the polyester polymer; and
(B) said oxygen scavenging composition comprising a polyamide polymer;
wherein the concentrate further comprises zinc.

60. The concentrate of claim 59, wherein the polyamide polymer is present in an amount of at least 15.0 wt. %, based on the weight of components (A) and (B).

61. The concentrate of claim 59, wherein zinc is present in an amount ranging from 1000 ppm to 5000 ppm.
